(19) United States
(12) Patent Application Publication
(10) Pub. No.: US 2012/0188084 A1
(43) Pub. Date: Jul. 26, 2012

(54) ENDOTRACHEAL TUBE CUFF PRESSURE MEASURING DEVICE

(76) Inventor: Nolan D. Shipman, Bryan, TX (US)

(21) Appl. No.: 13/425,835

(22) Filed: Mar. 21, 2012

Related U.S. Application Data
(63) Continuation-in-part of application No. 12/613,981, filed on Nov. 6, 2009.

(51) Int. Cl. G08B 21/02

(52) U.S. Cl. 340/573.1

(57) ABSTRACT

The invention relates to methods and devices related to improvements in the use of a medical breathing tube. In some embodiments, the invention reduces injuries, diseases and death associated with the use of said breathing tube. In preferred embodiments, said breathing tube reduces the risk of inadequate inflation in the lungs.

### CROSS-REFERENCE TO RELATED APPLICATIONS

This application is a continuation-in-part of U.S. patent application Ser. No. 12/613,981 entitled “Endotracheal Tube Cuff Pressure Measuring Device”, filed on. Nov. 6, 2009, which is incorporated herein by reference [1].

### FIELD OF INVENTION

The invention relates to methods and devices related to improvements in the use of a medical breathing tube. In some embodiments, the invention reduces injuries and diseases associated with the use of said breathing tube. In preferred embodiments, the present invention provides methods and devices to ensure proper pressure of an endotracheal tube cuff.

### BACKGROUND OF THE INVENTION

An endotracheal tube, also known as a breathing tube, is commonly used to maintain an unobstructed pathway to a patient's lungs, typically in the context of mechanical ventilation. The tube may be further supplemented with an endotracheal tube cuff, an apparatus that aids in the operation of an endotracheal tube, e.g. in the prevention of leaks in the ventilating circuit.

Tracheal intubation is one of the most common procedures performed in the operating room. The procedure involves the introduction of a plastic endotracheal tube (ET) into the patient's trachea to create an open channel for air and gas to flow. A balloon-inflatable tube sits at the distal end of the ET tube. The balloon inflates when pumped with air, ideally creating an airtight seal between the ET tube and trachea.

The amount of air pumped into the balloon is known as the “cuff pressure”. Maintaining adequate cuff pressure is critical for two major reasons. First, it ensures that an airtight seal is created that allow for effective oxygen and gas transfer. Second, the physical cuff prevents patient aspiration by restricting the buildup of mucous or vomits from accessing the lungs.

While it is critical that cuff balloons are inflated sufficiently, only a narrow range of pressure values (15-25 cm H₂O) is considered safe and appropriate. Pressures slightly above this range result in numerous physiological injuries such as the impedance of tracheal blood flow or tracheal damage. At 27 cm H₂O for example, blood flow at the cuff site can be reduced by 75% allowing for pathologic changes including ischemia, inflammation, ulceration, granulation, and stenosis.

The current paradigm toward maintaining adequate cuff pressure relies on a subjective finger palpation method, in which a pilot balloon attached to the distal end of the ET tube is “pinched” by hand to assess the adequacy of pressure. Numerous studies have found this “pinch” method to be highly imprecise in clinical practice [2-4]. For example, one such study involving a survey of 54 paramedics in New York City found that not a single paramedic was able to inflate an ET tube within the appropriate range of 12 cm to 25 cm H₂O. The group instead generated an average pressure of 105 cm H₂O [4]. Therefore, there exists a substantial clinical need for an improved method of monitoring internal pressures within endotracheal tubes using quantifiable standards of accuracy.

Maintaining endotracheal tube cuff pressures are important. Excessively high pressure in the cuff causes tracheal wall injury, while low pressure allows fluids to flow down the trachea into the lung and may result in diseases and disorders including but not limited to ventilator-associated pneumonia. The aforementioned disorders are difficult to treat and may result in death. Thus, there is a need to measure and correctively regulate tracheal tube cuff pressure.

### SUMMARY OF THE INVENTION

The invention relates to methods and devices related to improvements in the use of a medical breathing tube. In some embodiments, the invention reduces injuries and diseases associated with the use of said breathing tube. In preferred embodiments, the present invention provides methods and devices to ensure proper pressure of an endotracheal tube cuff, e.g. by continuously monitoring cuff pressure and alerting medical staff when the pressure is not optimum (e.g. not in the desired range of between 20-30 cm H₂O, and more preferably between 20-25 cm H₂O). In one embodiment, medical staff is alerted by an alarm (e.g. sound or, more preferably, a visual alarm, e.g. a red light, blinking light, and/or alphanumerical display of the cuff pressure). Thereafter, the medical staff can manually adjust the cuff pressure (up or down) using an inflating/deflating means, in order to return the pressure to optimum levels. In one embodiment, the cuff pressure is indicated on a display (e.g. a computer screen) located away from (e.g. outside the patient's room, e.g. at the nurse's station) the endotracheal tube. In one embodiment, an alarm indicating undesired cuff pressure is located away from (e.g. outside the patient's room, e.g. at the nurse's station) the endotracheal tube. In one embodiment, continuously monitoring cuff pressure is preferred over “spot checking” at intervals because the latter results in significant delays before improper pressures are detected. In one embodiment, the device is a compact and portable device that can fit in a shirt pocket, specifically designed for endotracheal tube cuff pressure “spot checking” by medical professionals.

In one embodiment, the invention contemplates a system comprising: an endotracheal tube cuff in fluid communication with a pressure transducer and cuff inflating/deflating mechanism, said pressure transducer capable of generating voltage and in electronic communication with a microcontroller, said microcontroller in electronic communication with an alarm. In one embodiment, said endotracheal tube cuff is attached to an endotracheal tube positioned in a patient. In one embodiment, said alarm is an audio alarm. In one embodiment, said alarm is a visual alarm. In one embodiment, said visual alarm is a display. In one embodiment, said display is an LCD display. In one embodiment, said alarm is remote from said tube cuff. In one embodiment, said alarm is visible from a nurse's station.

In one embodiment, the invention contemplates a method comprising: a) monitoring cuff pressure of endotracheal tube cuff with a pressure transducer, said tube cuff attached to an endotracheal tube, said tube positioned in a patient, said pressure transducer capable of generating voltage and in electronic communication with a microcontroller said microcontroller in electronic communication with an alarm; and b) alerting medical staff when the pressure is outside a desired range with said alarm. In one embodiment, said monitoring is continuous. In one embodiment, said monitoring is intermittent. In one embodiment, the desired range is 20-30 cm H₂O. In one embodiment, the desired range is 20-25 cm H₂O. In one embodiment, said alarm is an audible alarm. In one embodiment, said alarm is a visual alarm. In one embodiment, said alarm is remote from said tube cuff. In one embodiment, said alarm is visible from a nurse's station and said medical staff is alerted at said nurse's station. In one embodiment, said pressure sensor is also in fluid communication with a cuff inflating/deflating means. In one embodiment, said medical staff adjusts said pressure with said inflating/deflating means after being alerted in step b). In one embodiment, said adjusting comprises pushing or pulling on a syringe, said syringe in fluid communication with said tube cuff. In one embodiment, said monitoring of step a) comprises generating a voltage with said pressure transducer, and transmitting said voltage to said microcontroller.

In one embodiment, the invention contemplates a device comprising a housing comprising a port, said housing containing a pressure transducer in fluid communication with said port, said pressure transducer capable of generating voltage and in electronic communication with a microcontroller, said microcontroller in electronic communication with an alarm, said microcontroller positioned within said housing, said alarm visible from a surface of said housing. In one embodiment, said device is portable. In one embodiment, the invention further comprises an endotracheal tube cuff attached to said port and in fluid communication with said pressure transducer. In one embodiment, said alarm visible from a surface of said housing is a display. In one embodiment, said endotracheal tube cuff is further connected to a t-tube connection with a taper male fitting to a forward check valve and a syringe is connected to said t-tube through a forward check valve to said port and is in fluid communication with said pressure transducer.

It is not intended that the present invention be limited by the nature of the inflating/deflating means. In one embodiment, a communicating tube extends along all or part of the endotracheal tube, in fluid communication the cuff for inflating thereof. In one embodiment, the communicating tube terminates in a an inflation valve coupling for connecting the communicating tube and in turn the cuff to the other elements of the device as described herein. In one embodiment, the communicating tube terminates in a an inflation valve coupling which in turn connects via connecting the delivery tube and terminates in a coupling which in turn connects in fluidic communication to a three port stopcock/three-way manifold. In one embodiment, the three-port stopcock connects in fluidic communication through a coupling and in turn through a delivery tube and terminates in an inflation valve coupling. In one embodiment, a syringe connects in fluidic communication to the inflation valve coupling to the delivery tube. In one embodiment, the three-port stopcock connects in fluidic communication through coupling and in turn through a delivery tube and terminates in a pressure transducer.

In some embodiments, the invention relates to a device comprising: an endotracheal tube cuff connected to a tube comprising a polymer appropriate for use in medical applications (e.g. polyimide, ethylene vinyl acetate, etc.) subsequently connected to a manifold which is connected to (e.g. slidably engaging) both a syringe and a pressure transducer (e.g. the tubing may slide over a port or other opening in a housing containing the pressure sensor). The pressure sensor is subsequently connected to a microcontroller. The microcontroller is subsequently connected to a display, audio alarm, and is connected to computer operably linked to said microcontroller through a transmitter. In further embodiments, said tube is an endotracheal tube. In still further embodiments, said light emitting diode emits red light and green light. In additional embodiments, said data acquisition instrument is a National Instruments USB 6008. In some embodiments, said computer operably linked to said microcontroller is a National Instruments LabView computer. In some embodiments, said computer operably linked to said microcontroller is a PC.

The invention contemplates the above-described embodiments of the device operating as a “system,” as well as the device coupled to a ventilation circuit, thereby creating a coupled system for controlling cuff pressure an inflatable cuff of an endotracheal tube of an intubated patient. In one embodiment, said system can be calibrated by a calibration button operably linked to said microcontroller to reset the pressure reading, as ready by the pressure transducer, to 0 cm H₂O to enable accurate readings and to recalibrate said system.

In some embodiments, the invention relates to a method for treating a disease or disorder comprising: providing a subject at risk for or exhibiting symptoms associated with said disease or disorder, an embodiment of the device as described herein (e.g. an endotracheal tube cuff connected to a tube comprising a polymer appropriate for use in medical applications subsequently connected to a manifold which is connected to both a syringe and a pressure sensor) and administering said device under conditions such that the symptoms associated with said disease are reduced. In further embodiments, said disease or disorder is selected from the group consisting of pulmonary disease, pneumonia, pneumothorax, excess lung pressure, inadequate lung pressure, tooth damage, soft tissue damage, vocal cord damage, acute respiratory distress syndrome, tracheal rupture, tracheo-carotid artery erosion and tracheal innominate artery fistulas.

In some embodiments, the invention relates to a system comprising: an endotracheal tube cuff in fluid communication with a pressure transducer and a cuff inflating/deflating means, said pressure sensor capable of generating voltage and in electronic communication with a microcontroller, said microcontroller in electronic communication with an alarm. In some embodiments, the invention further relates to a system wherein said alarm is a visual alarm. In some embodiments, the invention further relates to a system wherein said system is hand-held. In some embodiments, the invention further relates to a system wherein said system is pocket sized. In some embodiments, the invention further relates to a system wherein said alarm is an alpha-numeric display. In some embodiments, the invention further relates to a system wherein said alarm is remote from said tube cuff. In some embodiments, the invention further relates to a system wherein said alarm is visible from a nurse's station.

In some embodiments, the invention further relates to a method for treating a disease or disorder comprising: a) providing: i) a subject intubated with an endotracheal tube at risk for or exhibiting symptoms associated with said disease or disorder (e.g. at risk because of the tube or tube cuff, including because of an improper pressure of the tube cuff), and ii) an embodiment of the device described herein (e.g. an endotracheal tube cuff in fluid communication with a pressure transducer and a cuff inflating/deflating means); b) administering said device under conditions such that the symptoms associated with said disease are reduced. In some embodiments, the said disease or disorder is a result of over-inflation of the endotracheal tube cuff. In some embodiments, the said disease or disorder is a result of under-inflation of the endotracheal tube cuff. In some embodiments, over-inflation of the endotracheal tube cuff is when endotracheal tube cuff is above 30 cm H₂O. In some embodiments, under-inflation of the endotracheal tube cuff is when endotracheal tube cuff is below 20 cm H₂O.

In some embodiments, the invention further relates to a method wherein said disease or disorder is selected from the group consisting of pulmonary disease, pneumonia, pneumothorax, excess lung pressure, inadequate lung pressure, tooth damage, soft tissue damage, vocal cord damage, acute respiratory distress syndrome, tracheal rupture, tracheo-carotid artery erosion and tracheal innominate artery fistulas.

In some embodiments, the device continuously measures the pressure of multiple cuffs (or multiple devices are used together with multiple cuffs, each device monitoring one cuff), including double-cuff tubes as described in U.S. Pat. No. 5,033,466, hereby incorporated by reference [5].

### DETAILED DESCRIPTION OF THE INVENTION

The invention relates to methods and devices related to improvements in the use of a medical breathing tube. In some embodiments, the invention reduces injuries and diseases associated with the use of said breathing tube. In preferred embodiments, the present invention provides methods and devices to ensure proper pressure of an endotracheal tube cuff.

In preferred embodiments, the invention relates to the use of an endotracheal tube. The endotracheal tube serves as an open passage through the upper airway. The purpose of endotracheal intubation is to permit air to pass freely to and from the lungs in order to ventilate the lungs. Endotracheal tubes can be connected to ventilator machines to provide artificial respiration. This helps in maintaining the patient's airway, especially during surgery. It is often used when patients are critically ill and cannot maintain adequate respiratory function to meet their needs. The endotracheal tube facilitates the use of a mechanical ventilator in these critical situations. If the tube is inadvertently placed in the esophagus (right behind the trachea), adequate respirations will not occur. Brain damage, cardiac arrest, and death can occur. Aspiration of stomach contents can result in pneumonia and acute respiratory distress syndrome. If the tube is placed too deep, it could result in only one lung being ventilated and can result in a pneumothorax as well as inadequate ventilation. During endotracheal tube placement, damage can also occur to the teeth, the soft tissues in the back of the throat, as well as the vocal cords.

Typically, an endotracheal tube terminates at one end in a coupling for coupling the tube to a supply tube that supplies the ventilating medium source. An inflatable cuff is provided at the other end of the endotracheal tube and extends around the tube so that on inflating of the cuff, the endotracheal tube is secured in the trachea of the subject and leak passed of the ventilating medium into the mouth of the subject is avoided during the inspiratory phase of each breathing cycle. As disclosed in U.S. Pat. No. 6,647,984 to O'Dea [6], hereby incorporated by reference, cuffs are typically inflated by manual manipulation of a syringe to a pressure adequate for retaining the endotracheal tube in the trachea and also for preventing any leaks of the ventilating medium. As provided for in Jaber et al., Intensive Care Medicine, 917-918 (2007), incorporated herein by reference [7], the large diameter/high volume low-pressure cuff has been a standard cuff used by practitioners for several decades. There is no tension within the wall of an inflated high volume low pressure cuff, thus all the intra-cuff pressure is transmitted to the tracheal wall, enabling easy monitoring of the tracheal wall pressure by direct measurement. Unfortunately, there is an inherent design fault with these high volume, low-pressure cuffs in that they allow pulmonary aspiration to occur even when correctly inflated.

Cuff pressure is a recognized factor in the pathogenesis of tracheal injury; even the high volume/low pressure cuff may cause mucosal damage over a short period. Areas of ciliary denudation and mucosa injury are seen as early as two hours after intubation. Measurement of intracuff pressure represents a simple and reproducible method of assessing the pressure exerted on the tracheal mucosa. The pressure within the tracheal cuff is assumed to be equal to the pressure exerted on tracheal lining because the high volume cuff does not show changes in pressure until it impinges on the tracheal wall as provided for in Vyas et al. (2002) Forum Anesthesiology 57, 266-283, incorporated herein by reference [8]. It has been suggested that the minimum occluding pressure required to achieve and adequate seal and reduce the risk of aspiration is 25 cm H₂O as disclosed in Vyas et al. (2002) Forum Anesthesiology 57, 266-283 [8], and Bernhard et al. (1979) Anesthesiology 50, 363-365 [9], both of which are hereby incorporated by reference. Pressures greater than 25 cm, H₂O up to two hours will denude mucosa down to the basement membrane as provided for in Vyas et al. (2002) Forum Anesthesiology 57, 266-283 [8], herein by reference. In this study, this limit was exceeded in 62% of patients. This may be due to inadvertent over inflation or an attempt to achieve an adequate seal in cases in which the initial tube is too small. The size of the tracheal tube is known to affect the intracuff pressure. Tracheal tubes that are much smaller than the trachea will require greater inflation to prevent an air leak and so will exert a higher pressure on the tracheal mucosa. The benefits of high volume-low pressure cuffs are lost by inflating the cuff above the minimum occlusion volume. It was further noted patients on intensive care are exposed to high cuff inflation pressures and hence pressures exerted on the trachea may also be excessive. It also shows that many intensive care units do not measure the cuff pressure regularly. It is recommended, on the basis of this study, that the cuff pressures in the intensive care units should be measured regularly and with any change in patient position or ventilation. Although this particular study recommends 25 cm H₂O as the recommended upper limit for the cuff pressure, various sources of literature indicate that 20-30 cm H₂O is considered to be the generally accepted recommended lower and upper limit for the cuff pressures.

A preferred embodiment of the present invention is a device capable of continuously monitoring the pressure of endotracheal tube cuffs. In one example of the use of the present invention, the device is operably arranged outside of a patient's body and connected to an endotracheal tube cuff that is resides inside said patient's body. The device measures the pressure of the endotracheal tube cuff and then transmits this pressure data to a computer monitored by a caregiver. In a preferred embodiment, the device comprises a display that displays the current pressure value as well as a graph of current and past pressures. The device, in one embodiment, comprises a visual alarm when pressure is either above or below the pressure range of 20-30 or 20-25 cm H₂O. The system further allows for manual inflation and deflation of the cuff with a syringe. This replicates the current method used by medical personnel so that doctors do not have to drastically change their methods to use this device.

In one embodiment, the device utilizes wireless technology to transmit the pressure data from the device to the computer at, for example, a nurses' station, allowing for the device to be used with each intubated patient in an intensive care unit (ICU) without having wires running from their rooms to the nurses' station. In one embodiment, said wireless communication is in the Bluetooth range. In another embodiment, the device functions while operably linked to a USB cable in lieu of wireless operation.

In one embodiment, the present invention contemplates a stand alone device that can be attached to an endotracheal tube cuff via a port, e.g. a device comprising a housing comprising a port (e.g. in a side wall), said housing containing a pressure transducer in fluid communication with said port (e.g. via tubing from said port to said pressure sensor), said pressure transducer capable of generating voltage and in electronic communication with a microcontroller in electronic communication with a display, within said housing, said display visible from a surface (e.g. a flush surface) of said housing. In one embodiment said device is shirt pocket sized.

### DETAILED DESCRIPTION OF PREFERRED EMBODIMENTS

The overall objective of this work was to design and manufacture a prototype able to monitor the internal pressures within a standard endotracheal (ET) tube. The team was specifically tasked with developing a device capable of detecting pressure levels, displaying the readings, and relaying the values to a local PC via Bluetooth connection. Particular emphasis was placed on maintaining portability and stand-alone functionality.

In one embodiment, the invention is a handheld digital pressure gauge operating on a high capacity lithium ion rechargeable battery. The gauge displays readings on an attached LCD and uses a Bluetooth module to transmit pressure readings to PCs located up to 35 feet away. Software developed in the Processing IDE further takes the data and uploads to online data brokerage system that provides continuous monitoring and feedback for multiple units.

FIG. 2 shows one embodiment of the present invention. The device (indicated generally by the reference numeral 1) for controlling cuff pressure an inflatable cuff 2 of an endotracheal tube 6 comprises a number of elements, which when linked to a ventilation circuit creates a cuff pressure control “coupled system.” The endotracheal tube 6 is inserted through the mouth 5 into the trachea 4 of a subject 8, and a coupling 12 on one end of the endotracheal tube 6 is provided for fluidic communication to a supply tube 13 for in turn connecting in fluidic communication to a ventilator 14. Ventilating medium is supplied to the subject from the ventilator 14. The coupling 12 element may be a “Y tube” or “Y-piece” with arms for the inspiratory line and an expiratory line and described in U.S. Pat. No. 7,334,580, hereby incorporated by reference [10]. The cuff 2 extends around an end 7 of the endotracheal tube 6. The cuff 2 contacts the walls of the trachea 4, and is inflated for sealing the endotracheal tube 6 in the trachea 4 for preventing leak past of ventilating medium into the mouth of the subject during the inspiratory phase of each breathing cycle. A communicating tube 9 extends along all or part of the endotracheal tube 6, and is (optionally) integrally formed therewith for communicating with the cuff 2 for inflating thereof. The communicating tube 9 terminates in a an inflation valve coupling 10 for connecting the communicating tube 9 and in turn the cuff 2 to the apparatus 1 as will be described. The communicating tube 9 terminates in a first inflation valve coupling 10 which in turn connects via connecting a first delivery tube 11 and terminates in a coupling 15 through a port 23 in the housing 31 which in turn connects in fluidic communication to a three port stopcock/ three-way manifold 16. The three port stopcock 16 connects in fluidic communication through coupling 18 in turn through a second delivery tube 19 and terminates in a second inflation valve coupling 20. The syringe 21 connects in fluidic communication via said second inflation valve coupling 20 to the delivery tube 19. The three port stopcock 16 connects in fluidic communication through coupling 17 in turn through a third delivery tube 22 and terminates in a Pressure Transducer 24 (e.g. through a port 23 in the housing 31). In one embodiment, the Pressure Transducer 24 connects electronically to the Microcontroller 25. In one embodiment, the Pressure Transducer 24 connects electronically to the Microcontroller 25. In one embodiment, the Pressure Transducer 24 connects electronically to the Microcontroller 25 and “push-button” used to calibrate the device 26. In one embodiment, pushing the calibration button 26 has the effect of setting the background pressure value (as measured by the Pressure Transucer 24) to be established at 0 cm H₂O. In one embodiment, said device 1 can be calibrated by a calibration button 26 operably linked to said Microcontroller 25 to reset the pressure reading as shown on a Display 28, as measured by the Pressure Transducer 24, to 0 cm H₂O to enable accurate readings and to recalibrate said device 1. In one embodiment, the Microcontroller 25 connects electronically to a Display 28, in some embodiments said Display is an LCD display. In one embodiment, the Display 28 indicates proper inflation level with display of the current pressure in cm H₂O. In one embodiment, the Microcontroller 25 connects electronically to an Audio Alarm 39. In one embodiment, said Audio Alarm 39 indicates proper inflation level with audio signals. In one embodiment, the Display 28 displays a graphical representation of power level in the Battery 27. The Microcontroller 25 optionally connects electronically to a Transmitter 29. In some embodiments said Transmitter 29 is a Bluetooth transmitter. In some embodiments said Transmitter is in wireless communication with an External Monitoring Receiver 30. In one embodiment, the Display 28 displays a graphical representation of activation of the Transmitter 29 and connectivity to an External Monitoring Receiver 30. In one embodiment, the Microcontroller 25 is powered by a Battery 27. In one embodiment, the device 1 is powered by a Battery 27. In one embodiment, the Battery 27 is a high capacity lithium ion rechargeable battery. In one embodiment, the Microcontroller 25 is powered by an external power source. In one embodiment, the device 1 is powered by an external power source. The Microcontroller 25 communicates electronically the pressure reading of the Pressure Transducer 24 to the Display 28. In one embodiment, the Pressure Transducer 24, Microcontroller 25, Calibration Button 26, Battery 27, Display 28, and optional Transmitter 29 are contained in a Housing 31. The Pressure Transducer 24 sends the information to Microcontroller 25, which causes the Display 28 to indicate when the pressure exceeds the desired high or low limits. In one embodiment, the Pressure Transducer 24 sends the information to Microcontroller 25, which causes the Audio Alarm 39 to indicate when the pressure exceeds the desired high or low limits. In one embodiment, the Pressure Transducer 24 sends the information to Microcontroller 25, which send information to the Transmitter 29 to transmit to the External Monitoring Reciever 30 to indicate when the pressure exceeds the desired high or low limits.

FIG. 3 shows one embodiment, of the present invention. The device (indicated generally by the reference numeral 1) for controlling cuff pressure an inflatable cuff 2 of an endotracheal tube 6 comprises a number of elements, which when linked to a ventilation circuit creates a cuff pressure control “coupled system.” The endotracheal tube 6 is inserted through the mouth 5 into the trachea 4 of a subject 8, and a coupling 12 on one end of the endotracheal tube 6 is provided for fluidic communication to a supply tube 13 for in turn connecting in fluidic communication to a ventilator 14. Ventilating medium is supplied to the subject from the ventilator 14. The coupling 12 element may be a “Y tube” or “Y-piece” with arms for the inspiratory line and an expiratory line and described in U.S. Pat. No. 7,334,580, hereby incorporated by reference [10]. The cuff 2 extends around an end 7 of the endotracheal tube 6. The cuff 2 contacts the walls of the trachea 4, and is inflated for sealing the endotracheal tube 6 in the trachea 4 for preventing leak past of ventilating medium into the mouth of the subject during the inspiratory phase of each breathing cycle. A communicating tube 9 extends along all or part of the endotracheal tube 6, and is (optionally) integrally formed therewith for communicating with the cuff 2 for inflating thereof. The communicating tube 9 terminates in a an inflation valve coupling 10 for connecting the communicating tube 9 and in turn the cuff 2 to the apparatus 1 as will be described. In one embodiment, the communicating tube 9 terminates in a first inflation valve coupling 10 which in turn connects via connecting a first delivery tube 11 and terminates in a Forward Check Valve 37 coupling with a Male Luer-Taper 32 in turn connects in fluidic communication to a T-Tube 33. In one embodiment, the coupling of said Forward Check Valve 37 with said Male Luer-Taper 32 enable fluidic communication with the inflatable cuff 2 of said endotracheal tube 6 and the Pressure Transducer 24. In one embodiment, the communicating tube 9 continues directly into an optional first inflation valve coupling 10 which in turn connects via connecting a first delivery tube 11 and terminates in a Forward Check Valve 37 interfaced with a Male Luer-Taper 32 in turn connects in fluidic communication to a T-Tube 33. In one embodiment, the endotracheal tube has a Pilot Baloon 38 on the first delivery tube 11. The T-Tube 33 connects in fluidic communication through a Forward Check Valve 34 in turn to the syringe 21 which can be adjusted to increase the air in the cuff 2. The syringe 21 is held into place by by a Syringe Clamp 35. In one embodiment, the coupling of said Forward Check Valve 37 with said Syringe 21 enables fluidic communication with the inflatable cuff 2 of said endotracheal tube 6 and the Pressure Transducer 24. The T-Tube 33 connects in fluidic communication through coupling 36 in turn through a third delivery tube 22 and terminates in a Pressure Transducer 24 (e.g. through a port 23 in the housing 31). In one embodiment, the Male Luer-Taper 32, T-Tube 33, Forward Check Valve 34, and Syringe Clamp 35 are contained within the housing 31 (such as in FIG. 5, FIG. 6, and FIG. 7). In one embodiment, the Pressure Transducer 24 connects electronically to the Microcontroller 25. In one embodiment, the Pressure Transducer 24 connects electronically to the Microcontroller 25 and “push-button” used to calibrate the device 26. In one embodiment, pushing the calibration button 26 has the effect of setting the background pressure value (as measured by the Pressure Transucer 24) to be established at 0 cm H₂O. In one embodiment, said device 1 can be calibrated by a calibration button 26 operably linked to said Microcontroller 25 to reset the pressure reading as shown on a Display 28, as measured by the Pressure Transducer 24, to 0 cm H₂O to enable accurate readings and to recalibrate said device 1. In one embodiment, the Microcontroller 25 connects electronically to a Display 28, in some embodiments said Display is an LCD display. In one embodiment, the Display 28 indicates proper inflation level with display of the current pressure in cm H₂O. In one embodiment, the Microcontroller 25 connects electronically to an Audio Alarm 39. In one embodiment, said Audio Alarm 39 indicates proper inflation level with audio signals. In one embodiment, the Display 28 displays a graphical representation of power level in the Battery 27. The Microcontroller 25 optionally connects electronically to a Transmitter 29. In some embodiments said Transmitter 29 is a Bluetooth transmitter. In some embodiments said Transmitter is in wireless communication with an External Monitoring Receiver 30. In one embodiment, the Display 28 displays a graphical representation of activation of the Transmitter 29 and connectivity to an External Monitoring Receiver 30. In one embodiment, the Microcontroller 25 is powered by a Battery 27. In one embodiment, the device 1 is powered by a Battery 27. In one embodiment, the Battery 27 is a high capacity lithium ion rechargeable battery. In one embodiment, the Microcontroller 25 is powered by an external power source. In one embodiment, the device 1 is powered by an external power source. The Microcontroller 25 communicates electronically the pressure reading of the Pressure Transducer 24 to the Display 28. In one embodiment, the Pressure Transducer 24, Microcontroller 25, Calibration Button 26, Battery 27, Display 28, and optional Transmitter 29 are contained in a Housing 31. The Pressure Transducer 24 sends the information to Microcontroller 25 which causes the Display 28 to indicate when the pressure exceeds the desired high or low limits. In one embodiment, the Pressure Transducer 24 sends the information to Microcontroller 25, which causes the Audio Alarm 39 to indicate when the pressure exceeds the desired high or low limits. In one embodiment, the Pressure Transducer 24 sends the information to Microcontroller 25, which send information to the Transmitter 29 to transmit to the External Monitoring Reciever 30 to indicate when the pressure exceeds the desired high or low limits.

In one embodiment, the current invention (dubbed “EndoShip II”) uses an MPXV70007DP Piezoelectric pressure transducer to measure air pressure between the ranges of −70 to +70 kPa for example FIG. 9. An Arduino Uno Platform houses a preprogrammed ATMega328 microcontroller used to provide on-board processing of the transducer's input (FIG. 10). A rechargeable high Capacity Lithium Ion battery pack is mounted to the back of the microcontroller providing a regulated supply of 5V power (FIG. 11). The microcontroller converts the pressure readings into units of cm H₂O (FIG. 12).

The values in FIG. 13 are further adjusted using a calibration algorithm for accuracy.

A series of if-then statements are used to identify pressure readings as being “Too Low” (<15 cm H₂O), “In Range” (15-25 cm H₂O), “Too High” (>25 cm H₂O), or “Out of Range” (<70 cm H₂O, >70 cm H₂O).

An attached LCD character screen displays the adjusted pressure readings and their associated safety level (FIG. 14). The program running on the PC then uploads the pressure readings every six seconds to an online data brokerage system Pachube (FIG. 16). Pachube creates an XML based feed of data which can be used to create numerous outputs such as: Google API Visualization Charts, SMS cell phone alerts, or live updating Excel spreadsheets (FIG. 17).

### DEFINITIONS

To facilitate the understanding of this invention, a number of terms are defined below. Terms defined herein have meanings as commonly understood by a person of ordinary skill in the areas relevant to the present invention.

One element is in “fluid communication” or “fluidic communication” with another element (and thereby “connected” to another element) when it is attached through a channel, tube or other conduit that permits the passage of gas, vapor and the like. Indeed, the tubing associated with commercially available ventilators creates a “circuit” for gas flow by maintaining fluidic communication between the elements of the circuit. Ports in the circuit allow for the circuit to be completed with tubing. “Tubing” can be made of a variety of materials, including put not limited to various plastics, metals and composites. Tubing can be rigid or flexible. Tubing can be “attached” in a detachable mode or a fixed mode. Tubing is typically attached by sliding into or over (both of which are examples of “slidably engaging”) other tubing or connectors (also called “couplings”).

In some embodiments, certain elements are in electronic communication with other elements (and thereby “communicate electronically”). “Electronic communication” can be implemented in a hard-wired electrical connection, e.g., a shielded cable, or an optical connection, e.g., an optical fiber, a wireless communication, e.g., infrared or radiowaves, a combination thereof, and the like.

A pressure sensor measures pressure, typically of gases or liquids. Pressure is an expression of the force required to stop a fluid from expanding, and is usually stated in terms of force per unit area. A pressure sensor usually acts as a transducer; it generates an electrical signal as a function of the pressure imposed. Pressure sensors can also be used to indirectly measure other variables such as fluid/gas flow, speed, water level, and altitude. Pressure sensors can alternatively be called pressure transducers, pressure transmitters, pressure senders, pressure indicators and piezometers, manometers, among other names.

A microcontroller (sometimes abbreviated μC, uC or MCU) is a small computer on a single integrated circuit containing a processor core, memory, and programmable input/output peripherals. Program memory in the form of NOR flash or OTP ROM is also often included on chip, as well as a typically small amount of RAM. Microcontrollers are designed for embedded applications; such microcontrollers are also referred to as preprogrammed microcontrollers.

The term display refers to an electronic display. The invention is not limited to the specific type of electronic display. In some embodiments the display is a liquid crystal display (LCD) which is a thin, flat electronic visual display that uses the light modulating properties of liquid crystals (LCs). In some embodiments the display are selected from the following types: Light-emitting diode display (LED), Electroluminescent display (ELD), Plasma display panels (PDP), Liquid crystal display (LCD) such as HPA display or Thin-film transistor displays (TFT), and Organic light-emitting diode displays (OLED).

The term transmitter is usually limited to equipment that generates radio waves for communication purposes; in the case of the invention it also encompasses any necessary equipment, such as an antenna, to produces radio waves. Transmitters are necessary component parts of many electronic devices that communicate by radio, such as cell phones, Wifi and Bluetooth enabled devices.

A check valve, clack valve, non-return valve or one-way valve is a mechanical device, a valve, which normally allows fluid (liquid or gas) to flow through it in only one direction.

As used herein, “endotracheal tube” or “breathing tube” refers to a device used to aid the airway management and mechanical ventilation of a subject under anesthesia, intensive care or emergency medical care, including but in no way limited to a subject who are undergoing or who have recently undergone surgery including but not limited to thoracic surgery, a subject who has experienced a physical trauma including but not limited to thoracic and cardiothoracic trauma, a subject under the influence of at least one local or general anesthesia, or a subject experiencing loss of consciousness including but not limited to a subject in a medically induced or non-medically induced coma. The act of inserting an endotracheal tube or breathing tube is referred to as “intubation.”

An “endotracheal tube cuff” is an apparatus operably linked to an endotracheal tube capable of manipulating the pressure and volume of gas transferred into a patient using an endotracheal tube. Such cuffs are described generally in U.S. Pat. No. 5,067,497, hereby incorporated by reference [11].

“Pneumothorax,” also known as “collapsed lung,” is a condition caused by the accumulation of air or gas in the pleural cavity. While not limiting the present invention to the conditions under which a subject acquires pneumothorax, the condition may result from a disease or from physical injury.

“Subject” refers to any mammal, preferably a human patient.

As used herein, the terms “prevent” and “preventing” include the prevention of the recurrence, spread or onset of a disease or disorder. It is not intended that the present invention be limited to complete prevention. In some embodiments, the onset is delayed, or the severity of the disease or disorder is reduced.

As used herein, the terms “treat” and “treating” are not limited to the case where the subject (e.g. patient) is cured and the disease is eradicated. Rather, the present invention also contemplates treatment that merely reduces symptoms, improves (to some degree) and/or delays disease progression. It is not intended that the present invention be limited to instances wherein a disease or affliction is cured. It is sufficient that symptoms are reduced.

### BRIEF DESCRIPTION OF THE DRAWINGS

FIG. 1 is a diagram of an endotracheal tube cuff in a subject.

FIG. 2 is a schematic showing one embodiment of the device of the present invention in the context of a ventilation circuit, thereby creating a cuff pressure control coupled system.

FIG. 3 is a schematic showing another embodiment of the device of the present invention in the context of a ventilation circuit, thereby creating a cuff pressure control coupled system.

FIG. 4 shows endotracheal tubes with A) a pilot inflation balloon and Forward-Check Valve. The forward-check valve prevents pressure from leaving the cuff once the syringe has been removed. The forward check valve comes attached to the standard ET tube and cannot be removed. B) A lauer taper male fitting illustrating the airflow. A luer taper male fitting can open the forward-check valve in both airflow directions. Care must be taken, as with bidirectional airflow as there is an increased chance of air pressure within the cuff being leaked out. This is addressed with proper tube fitting and guarding against user error.

FIG. 5 shows one arrangement of the outer surface of the invention where A) the connection of the male luer-taper attachment to the t-tube. The t-tube is connected to tubing to the pressure transducer and on another connection is the forward check valve arranged in alignment with the syringe clamp. In B) the syringe is in the syringe clamp and engaged with the forward check valve.

FIG. 6 shows one arrangement of the outer surface of the device where the male luer-taper is engaged with the endotracheal tube cuff.

FIG. 7 shows one arrangement of the outer surface of the invention, which shows the front and the back of the device.

FIG. 8 shows a snapshot of one embodiment of the current invention (Left) and a screenshot of PC display (Right).

FIG. 9 shows a MPXV7007DP pressure transducer onboard the current invention.

FIG. 10 shows the Arduino Uno Platform with the ATMega328 Microcontroller.

FIG. 11 shows a Lithium Ion Battery Pack.

FIG. 12 shows an Arduino IDE used to program microcontroller.

FIG. 13 shows a calibration algorithm programmed into prototype of the current invention.

FIG. 14 shows a LCD displaying pressure value and safety level embodiment of the current invention.

FIG. 15 shows a Bluetooth module that lights green to indicate connection to PC.

FIG. 16 shows Processing IDE (right) relays values to web server at Pachube (left).

FIG. 17 shows XML feed from Pachube is used to generate interactive graph using Google API.

FIG. 18 shows a schematic of pressure accuracy test.

FIG. 19 shows graphs for Prototype Pressure Accuracy vs. KrosFlow Standard from 0-50 cm H₂O (top) and from 10-40 cm H₂O (bottom) (n=3). Key Points: Reported pressure values from prototype strongly follow linear relationship (r²=0.995) closely matching that of the standard. Standard deviations between 3 test runs are minimal indicating high precision of prototype.

FIG. 20 shows a schematic of Bluetooth transmission range.

FIG. 21 shows a schematic of battery life test.

FIG. 22 shows a schematic of the failure creep test.

FIG. 23 shows pressure sensor accuracy at low battery levels. Reported pressure values show that even at low battery levels prototype maintains strong linear relationship (r²=0.999). Standard deviations between three runs at low battery level remains low indicating the maintenance of precision.

FIG. 24 shows top face (top) and side face view (bottom) of one prototype of the current invention.

FIG. 25 shows top face (top) and back face view (bottom) of one prototype of the current invention.

FIG. 26 shows the exposed components overlaid on PCB, components shown include a (1) an LCD Display, (2) Pressure sensor, and (3) the reset button for calibration.

FIG. 27 shows a PCB diagram of one embodiment of the present invention.

FIG. 28 shows a circuit diagram of one embodiment of the present invention.

FIG. 29 shows one prototype of the current invention

FIG. 30 shows one prototype of the current invention.

FIG. 31 shows the front of one embodiment of the present invention.

FIG. 32 shows another embodiment of the present invention with attached battery power source.

FIG. 33 shows a flowchart of operation for the major components of one embodiment of the present invention.

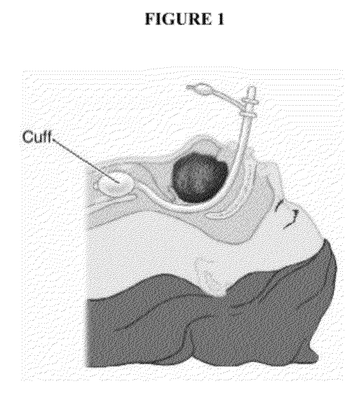

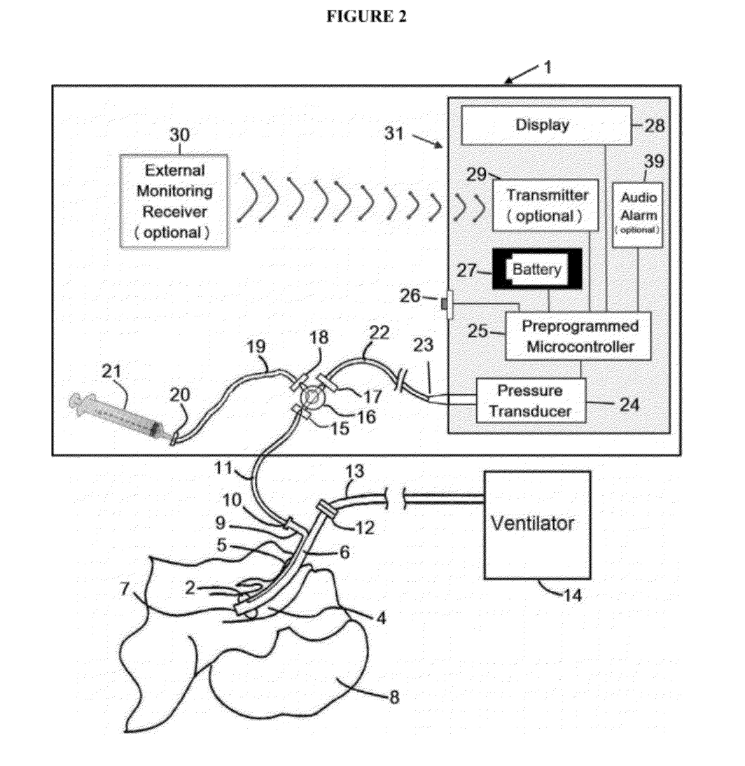

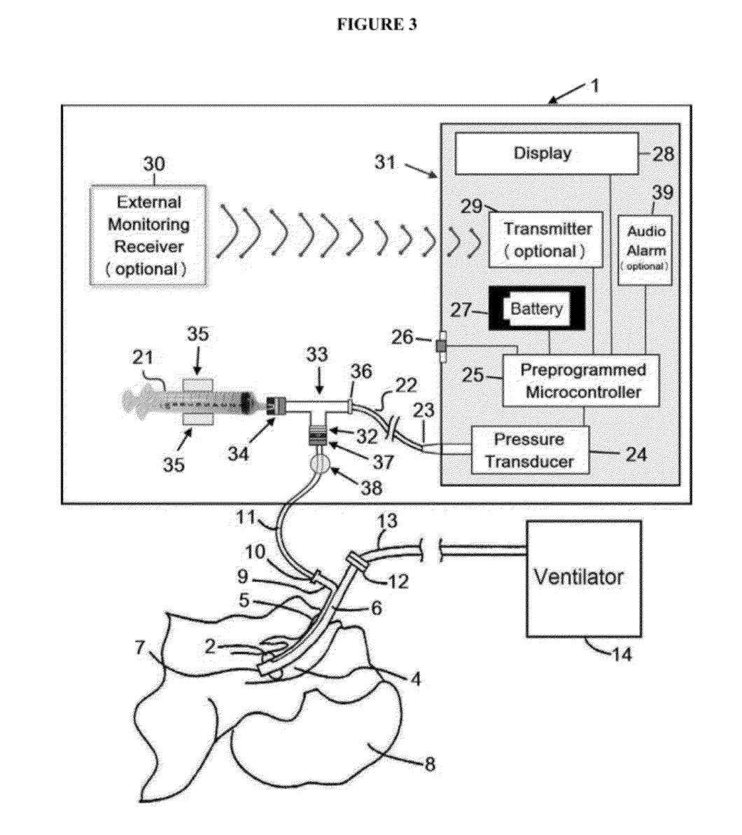

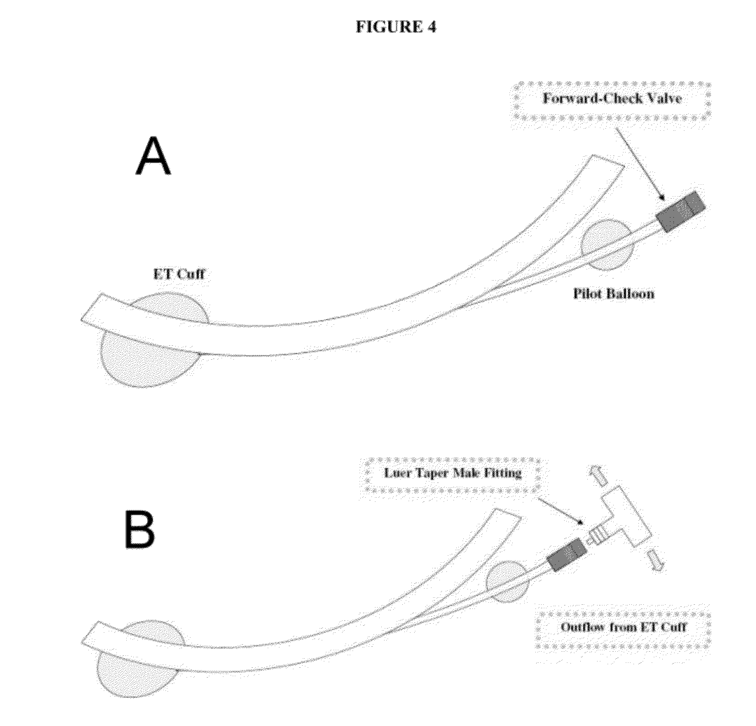

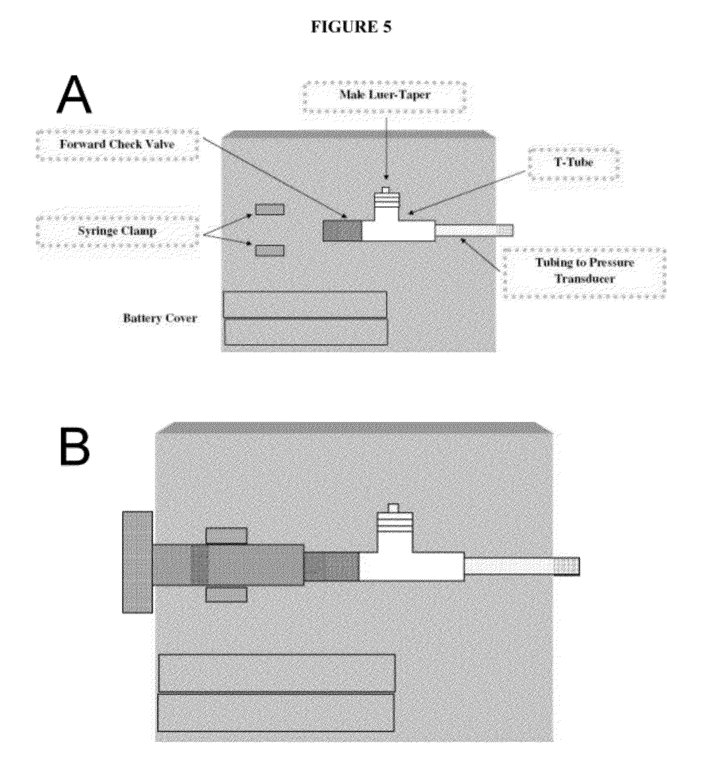

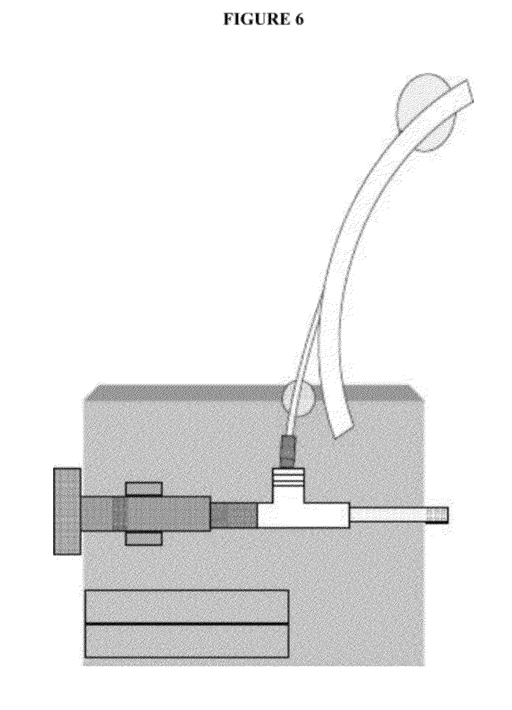

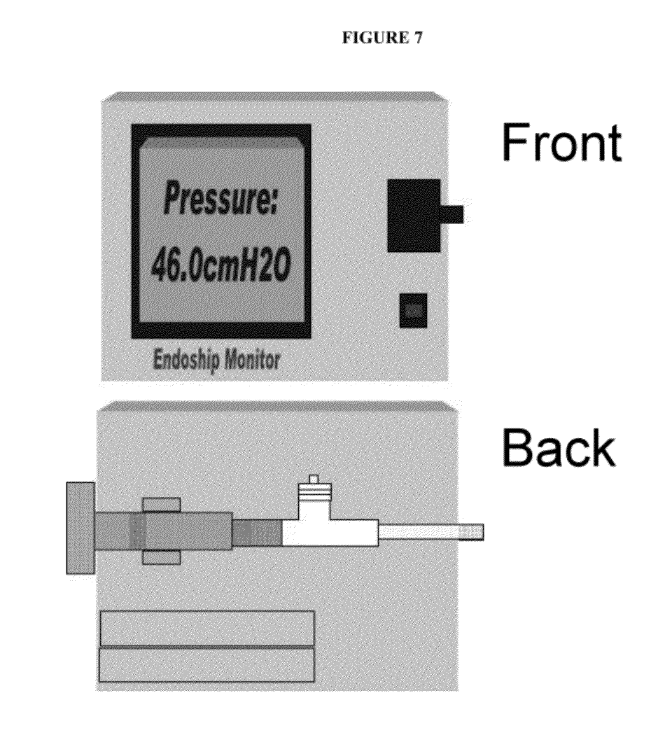

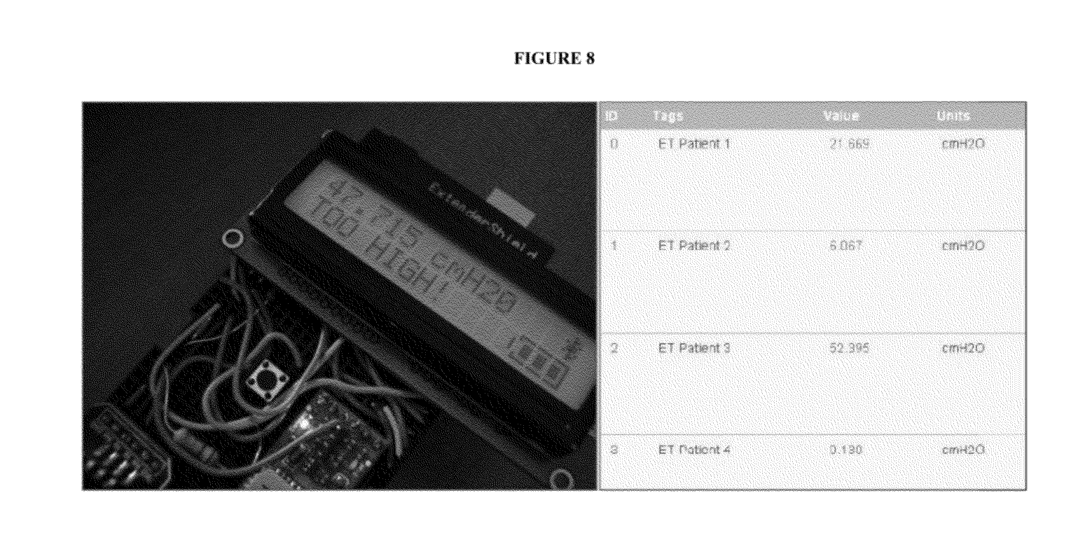

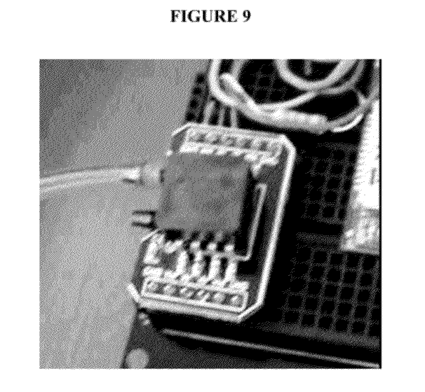

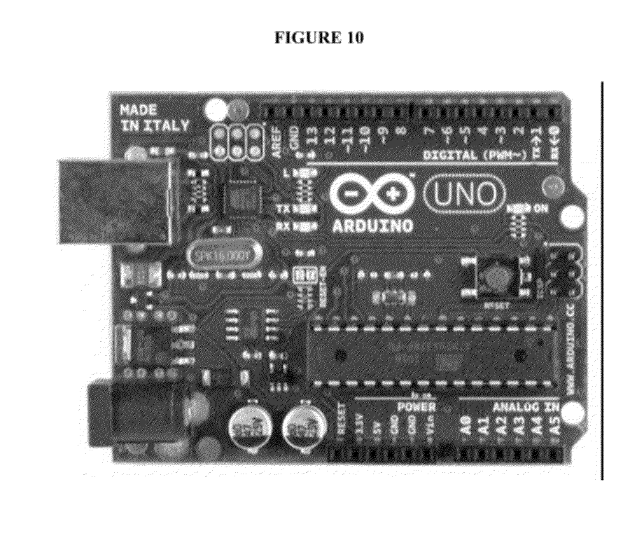

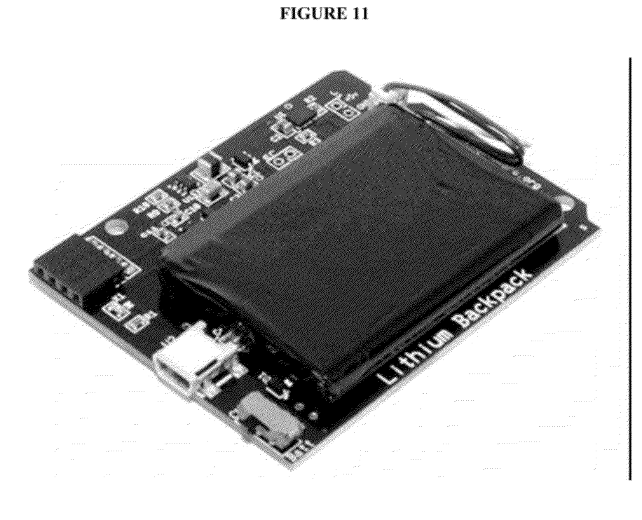

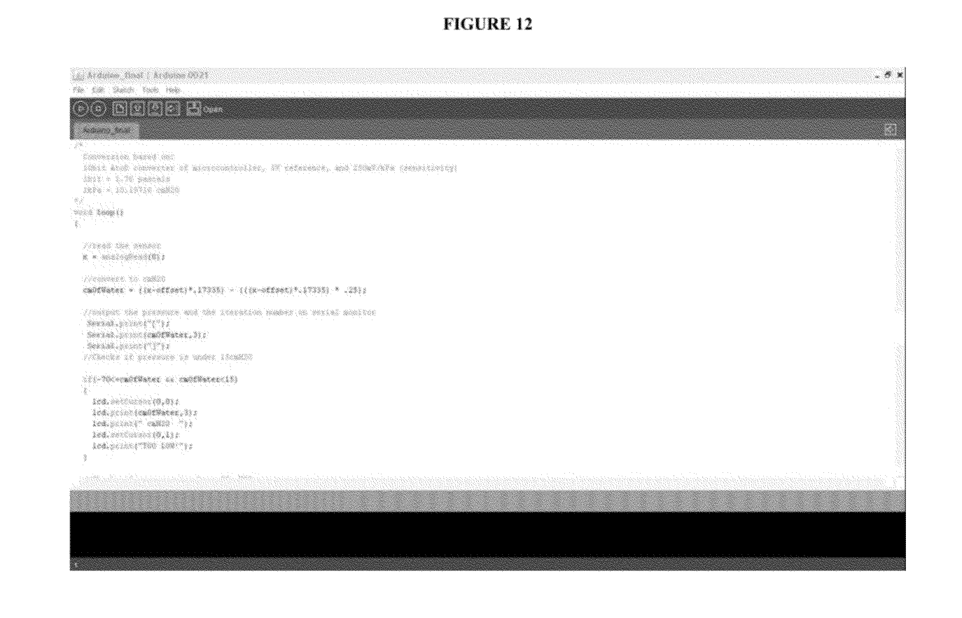

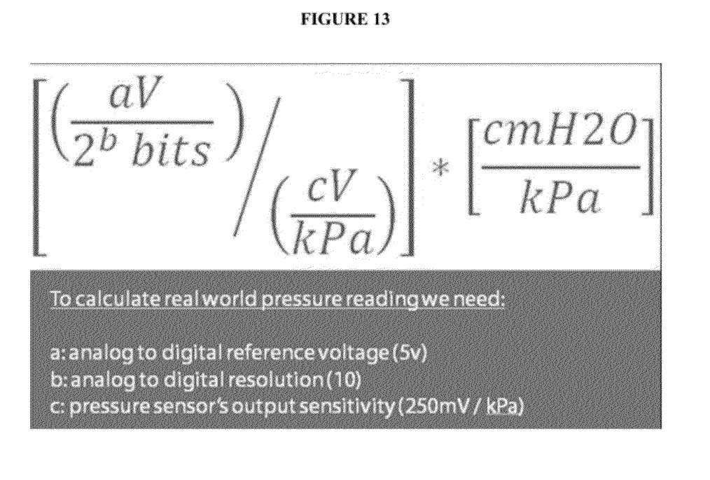

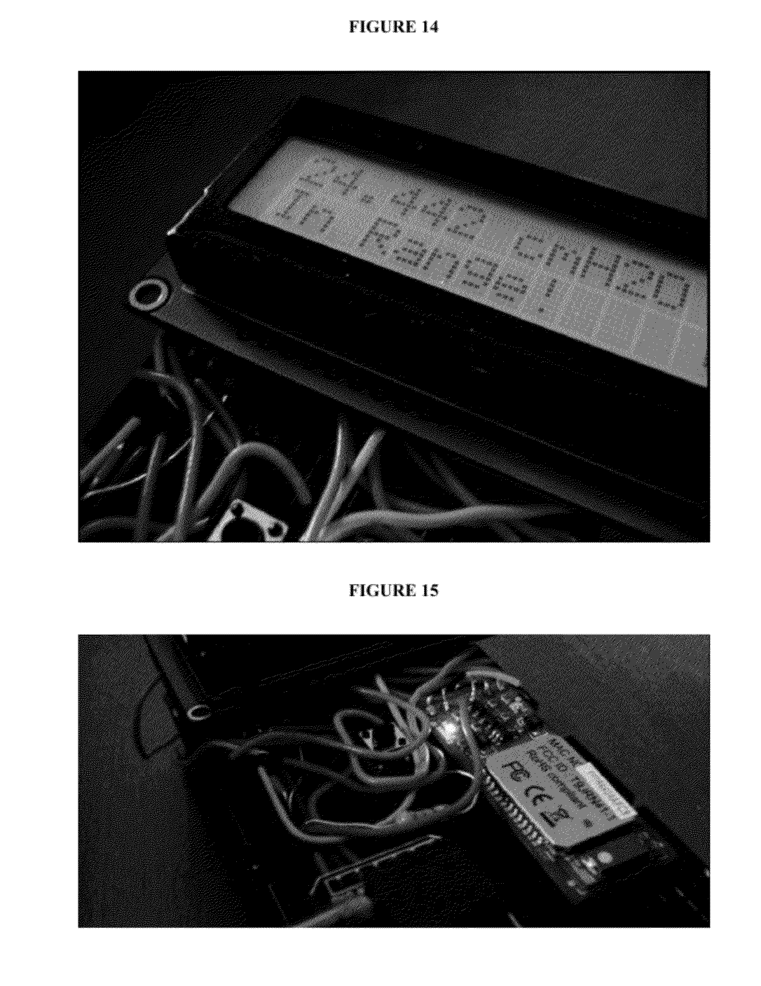

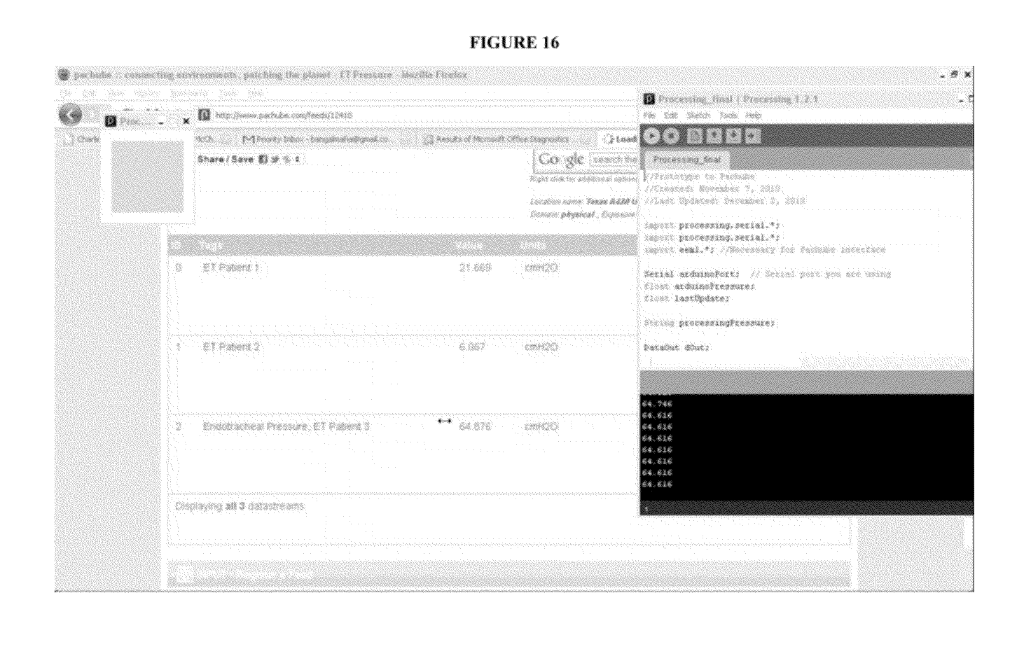

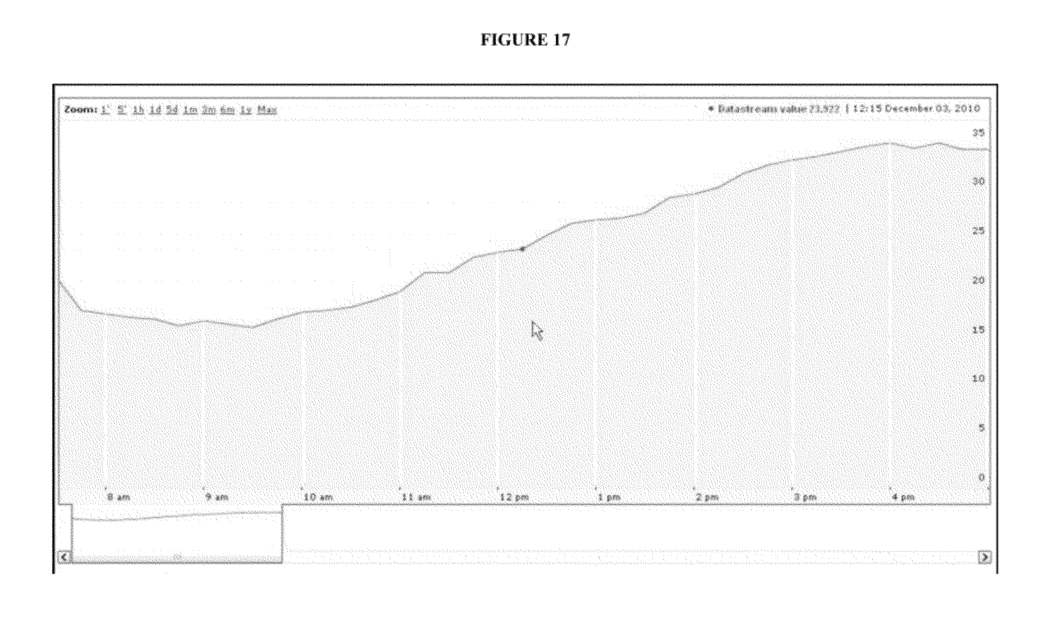

Table 1 shows prototype specifications.

Table 2 shows required specifications vs. delivered specifications.

Table 3 shows pressure sensor accuracy from 0-50 cm H₂O. Reported pressure values from prototype match closely with true values. Statistical analysis via paired Student's T-Test confirm pressure deviations to be non-significant (p<0.10) through all pressure levels. T-Test further shows accuracy levels increase between 20-40 cm H₂O (p<0.01). Highlighted rows roughly indicate primary levels of interest in endotracheal tube pressure monitoring.

Table 4 shows Bluetooth transmission range testing. Bluetooth transmission connection safely held within 10 meters (35 feet). Distance sufficiently covers standard operating room. Further tests show transmission ranges can exceed this distance; however, significant variability appears present.

Table 5 shows battery life testing. Initial test shows battery life exceeds 5-hour minimum requirement set in design objectives. Further tests will be necessary to confirm battery life consistency.

Table 6 shows pressure sensor accuracy at low battery levels. Reported pressure values from prototype at low battery levels closely match with true values. Statistical analysis via paired Student's T-Test confirm pressure deviations to be non-significant (p<0.10) through all pressure levels. Test confirms that failure creep is not a significantly detrimental issue to the current prototype's accuracy.

Table 7 shows summarized prototype dimensions of one embodiment of the invention. Prototype dimensions fall below those specified in objectives (>8×15×5 cm, >51bs).

Table 8 shows a table description of the components of one embodiment of the current invention.

### EXAMPLES

### A. Accuracy of Reported Pressure Readings

### Test Method:

A 3 ml syringe was attached to a SpectrumLabs KrossFlow Pressure Gauge. Syringe pump was depressed to discrete intervals of 0.05 ml from 0.0-0.40 mL. Pressure readings from gauge were recorded for each interval. These values were designated as the “true input pressures” for each depression level. The syringe was then disconnected from the KrossFlo Gauge.

EndoShip II Prototype was subsequently attached to the syringe in precisely the same configuration as the previous gauge. Syringe pump was depressed through the same intervals. The prototype's reported values were recorded.

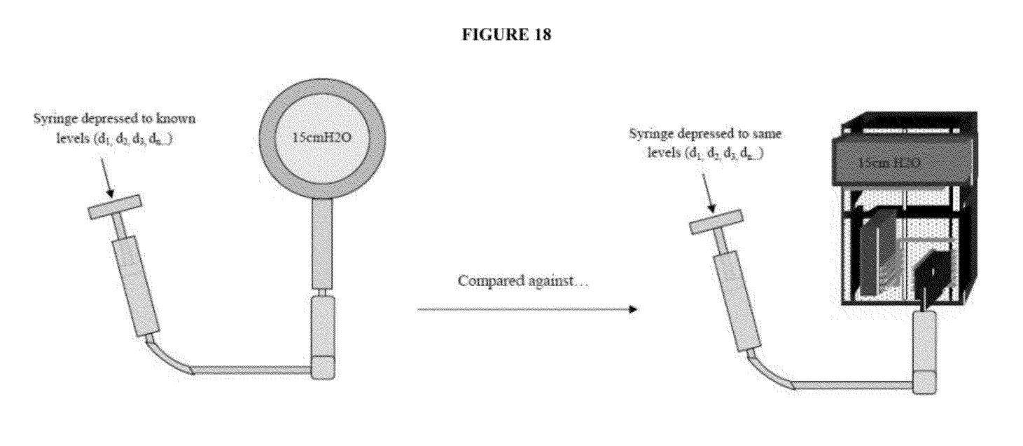

Obtained pressure values from the two gauges were then compared for each interval (FIG. 18).

### Test Key Points (Table 3):

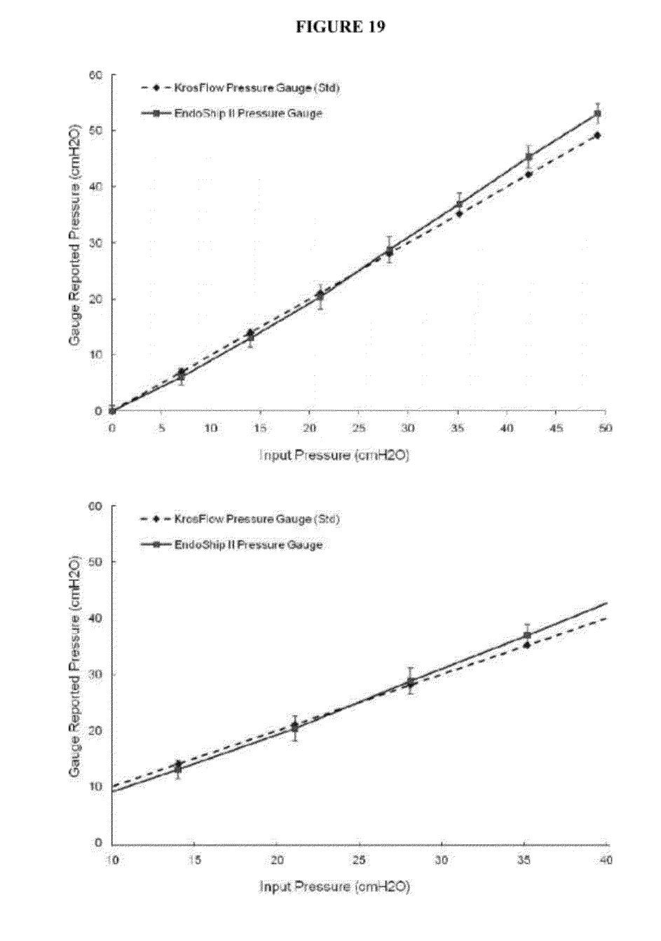

Reported pressure values from prototype match closely with true values. Statistical analysis via paired Student's T-Test confirm pressure deviations to be non-significant (p<0.10) through all pressure levels. T-Test further shows accuracy levels increase between 20-40 cm H₂O (p<0.01).
Highlighted rows roughly indicate primary levels of interest in endotracheal tube pressure monitoring.
   Prototype Pressure Accuracy vs. KrosFlow Standard from 0-50 cm H₂O (left) and from 10-40 cm H₂O (right) (n=3) (FIG. 19).

### Key Points:

Reported pressure values from prototype strongly follow linear relationship (r²=0.995) closely matching that of the standard.
Standard deviations between 3 test runs are minimal indicating high precision of prototype.

### B. Bluetooth Transmission Range

### Test Method:

A 3 ml syringe was attached to a SpectrumLabs KrossFlow Pressure Gauge. Syringe pump was depressed to discrete intervals of 0.05 ml from 0.0-0.40 mL. Pressure readings from gauge were recorded for each interval. These values were designated as the “true input pressures” for each depression level. The syringe was then disconnected from the KrossFlo Gauge.

EndoShip II Prototype was subsequently attached to the syringe in precisely the same configuration as the previous gauge. Syringe pump was depressed through the same intervals. The prototype's reported values were recorded (Schematic of Bluetooth Transmission Range FIG. 20).

Obtained pressure values from the two gauges were then compared for each interval.

### Results:

### Table 4: Bluetooth Transmission Range Testing

### Key Points:

Bluetooth transmission connection safely held within 10 meters (35 feet). Distance sufficiently covers standard operating room.
Further tests show transmission ranges can exceed this distance; however, significant variability appears present.

### C. Battery Life

### Test Method:

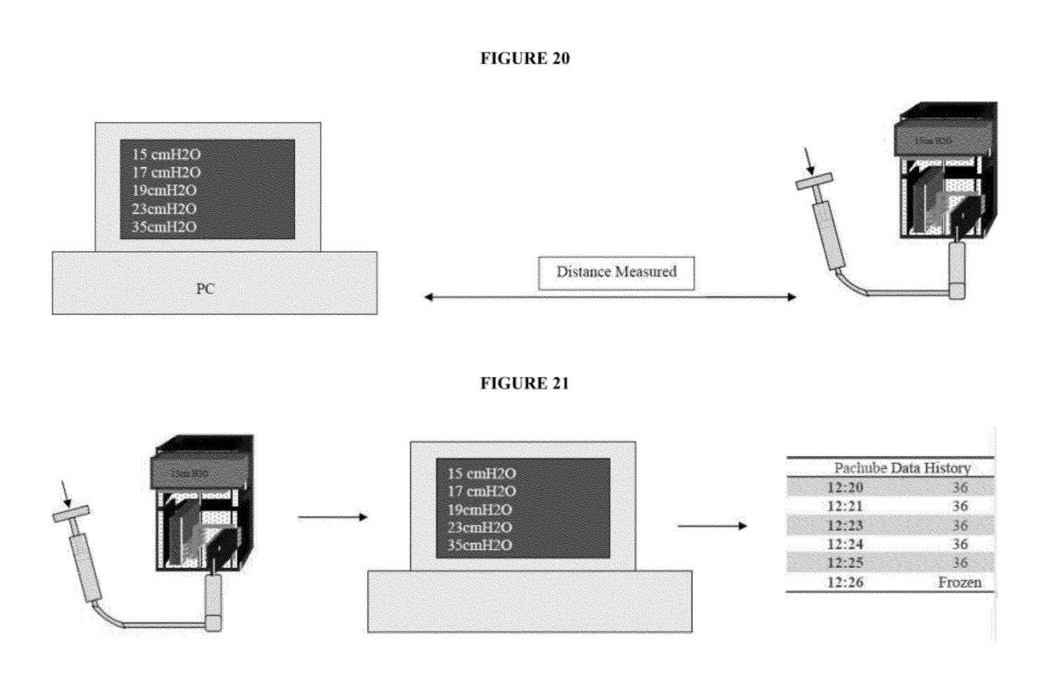

Prototype was first charged to its maximum overnight. A syringe was attached to the pressure sensor through airtight tubing and slightly depressed. The time of this attachment was noted. The battery-powered prototype was then paired to a central PC via Bluetooth connection. A Processing program continuously transmitted these pressure readings from the prototype to the Pachube data brokerage system. Once the prototype exhausted its battery life, no further readings were sent to the server. This time point was automatically detected/saved by Pachube and could be used to determine total run time of the prototype (FIG. 21).

### Table 5: Battery Life Testing

### Key Point:

Initial test shows battery life exceeds 5-hour minimum requirement set in design objectives.
Further tests will be necessary to confirm battery life consistency.

### D. Failure Creep

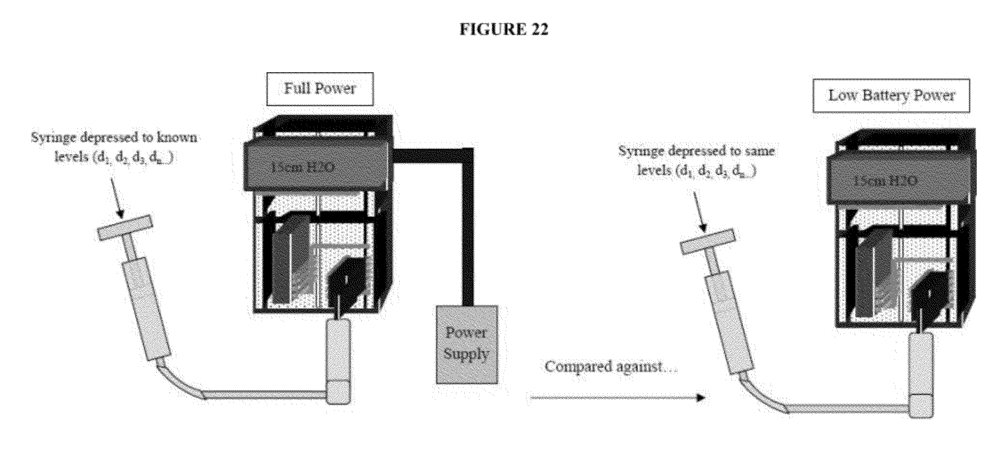

### Test Method (FIG. 22):

Prototype's battery was left to nearly complete discharge (less than 10 minutes of life remaining). Five pressure readings were taken using a syringe depressed to known levels. A power cord was then attached to the prototype and the syringe was once again depressed to the same levels. Pressure readings between the two tests were then compared.

The justification behind the test is that pressure readings displayed while the power cord is attached indicates an “accurate reading”. If pressure values obtained on minimal battery power match these accurate readings the issue of failure creep can be dismissed.

### Table 6: Pressure Sensor Accuracy at Low Battery Levels

### Key Points:

Reported pressure values from prototype at low battery levels closely match with true values. Statistical analysis via paired Student's T-Test confirm pressure deviations to be non-significant (p<0.10) through all pressure levels.
Test confirms that failure creep is not a significantly detrimental issue to the current prototype's accuracy.

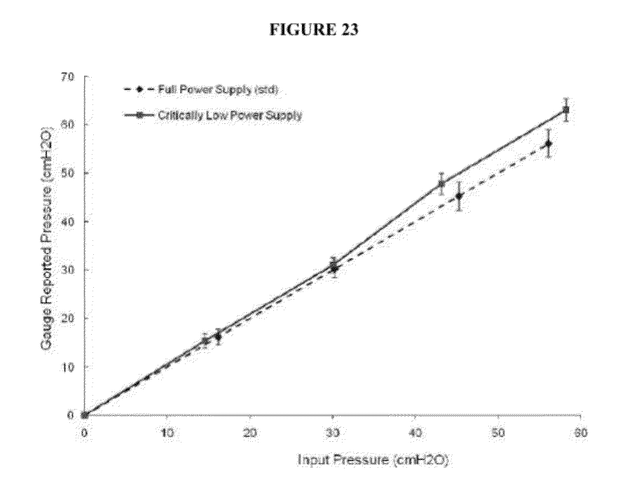

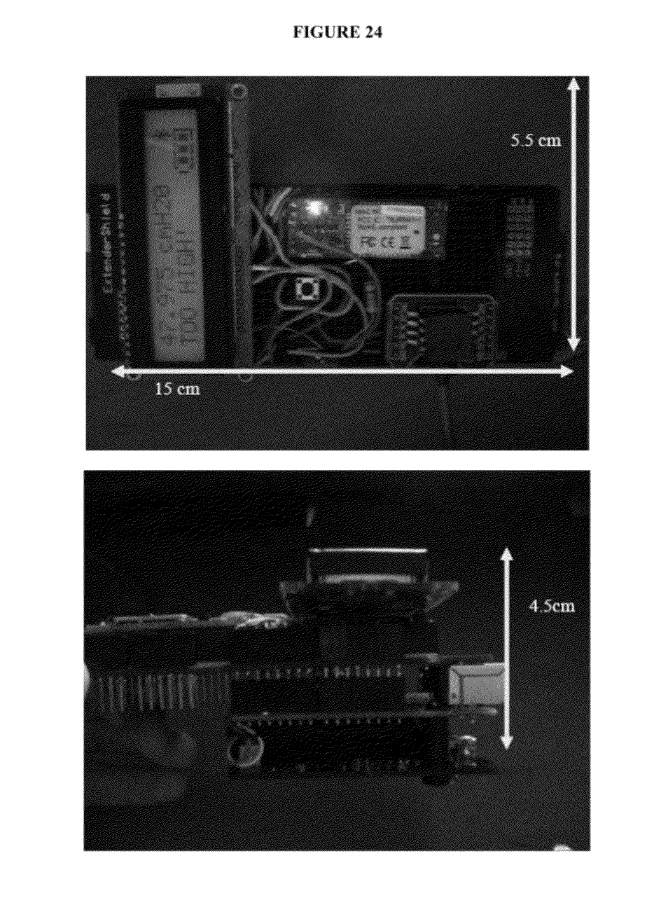

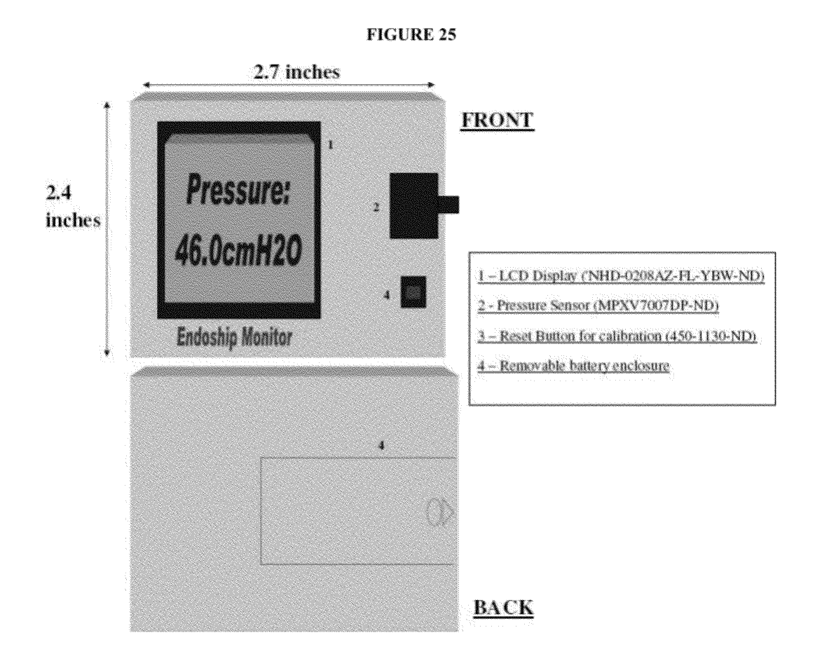

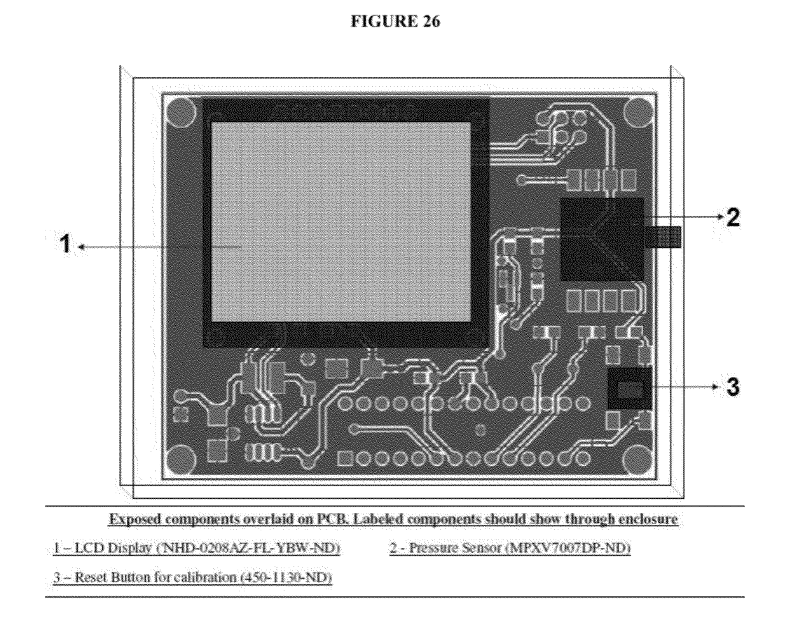

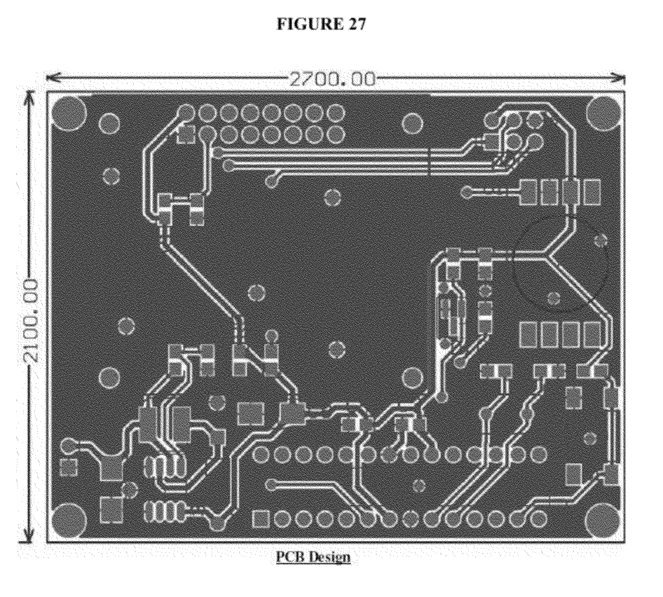

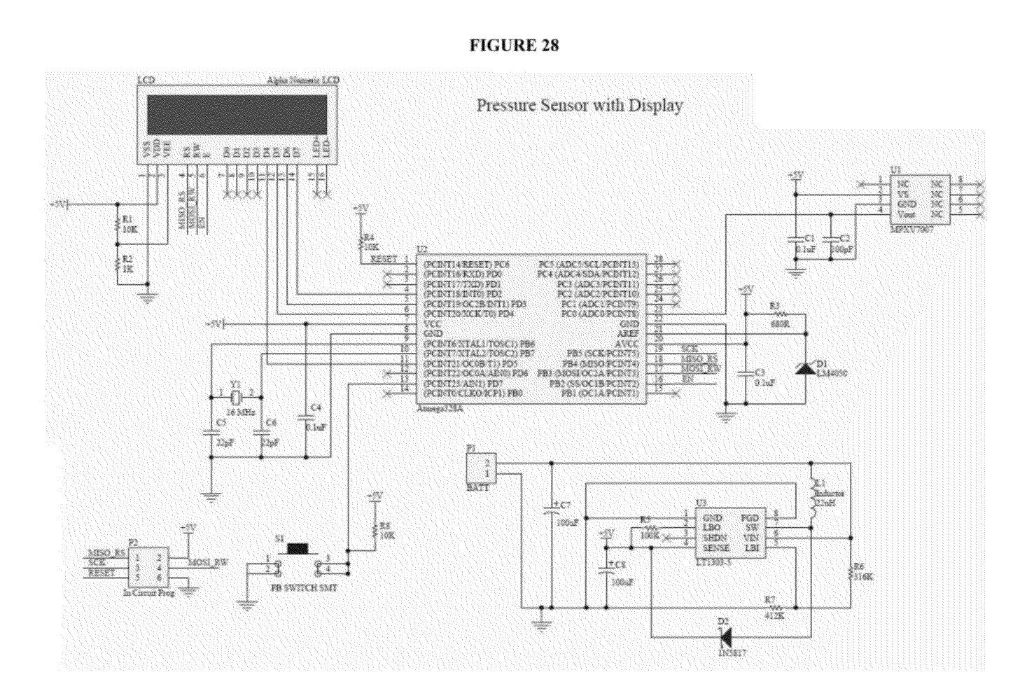

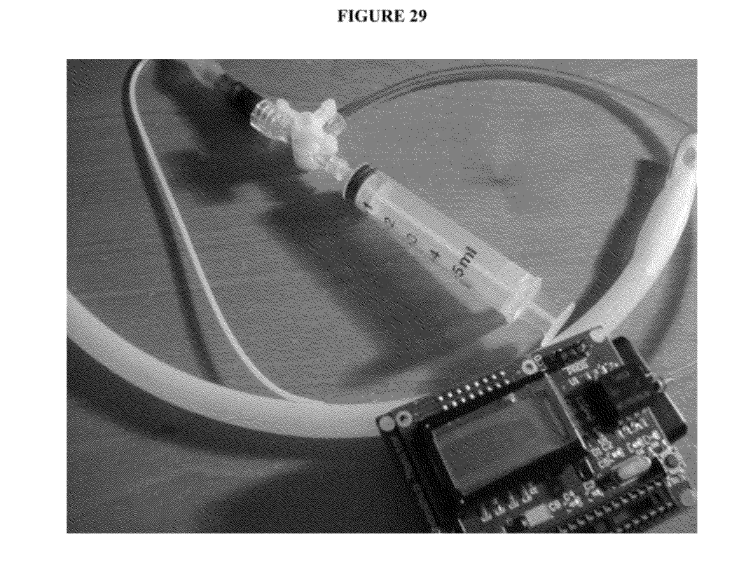

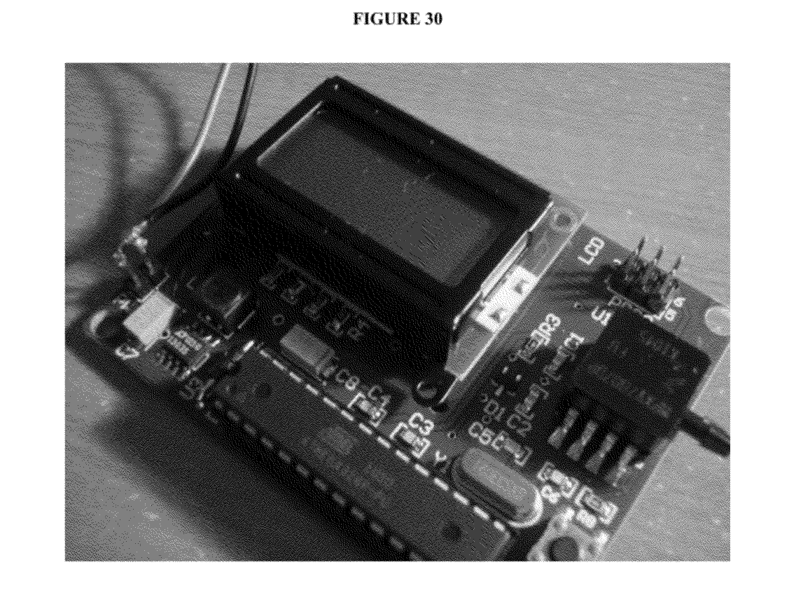

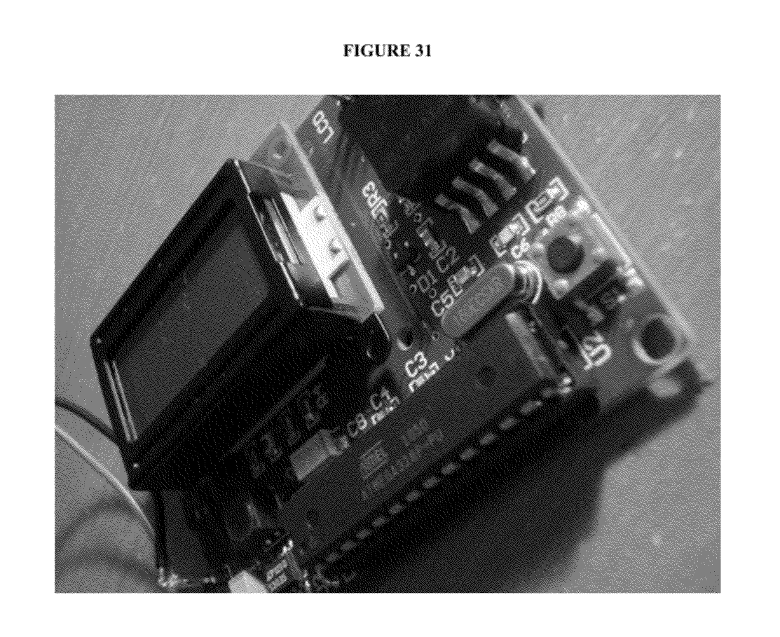

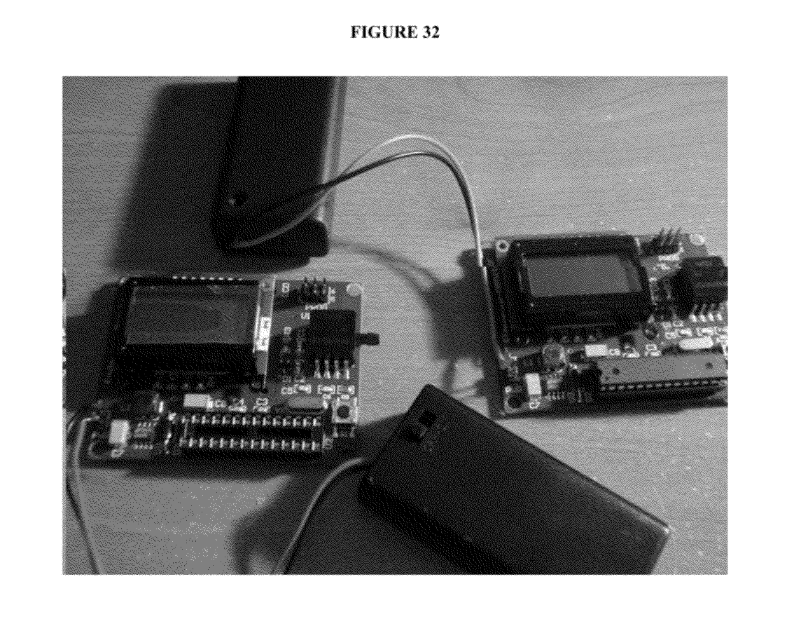

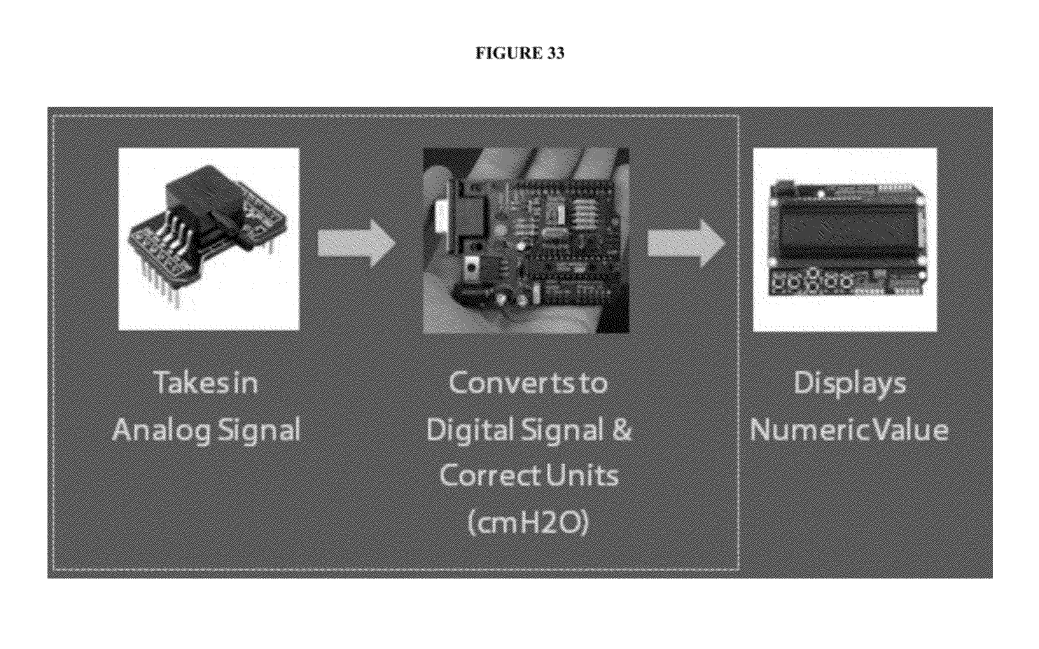

### FIG. 23: Pressure Sensor Accuracy at Low Battery Levels

### Key Points:

Reported pressure values show that even at low battery levels prototype maintains strong linear relationship (r²=0.999)
Standard deviations between three runs at low battery level remains low indicating the maintenance of precision.

### E. Physical Dimensions

### Test Method:

Standard measurements (length, width, thickness) were taken. Mass was measured using Mettler Toledo P8302-5 Balance.

### Table 7: Summarized Prototype Dimensions

### Key Point:

Prototype dimensions fall below those specified in objectives (>8×15×5 cm, >51 bs).

### VII. Software Code

### Arduino Code:

Software below is programmed into the ATMega microcontroller. It was originally programmed on the Arduino programming platform. It is used to convert analog pressure readings detected in the MPX pressure sensor into digital values. These values are then further processed into numeric units of cm H₂O and outputted to an LCD display.

#include <EEPROM.h>
#include <LiquidCrystal.h>
// Reads from Pressure Transducer, Converts to cmH2O, Checks against 15-25cmH2O safety range,
Displays to LCD
// Batterylife indicator also displayed
// Initiated: October 24, 2010
// Last Modified: December 4, 2010
int offset = 0;
LiquidCrystal lcd(12, 11, 10, 5, 4, 3, 2);
//Setting up the Battery indicator / Bluetooth Indicator
int backLight = 13;
int buttonPin = 7;
int buttonState = 0;
int battPin = 2;
float battState = 0;
int number = 0; //number of iterations
int x; // fresh value from sensor
float cmOfWater; //after multiplication
byte batt0[8]={
B11111,
B00001,
B11101,
B11101,
B11101,
B11101,
B00001,
B11111};
byte batt1[8]={
B11111,
B00001,
B00001,
B00001,
B00001,
B00001,
B00001,
B11111};
byte batt2[8]={
B11111,
B00000,
B01110,
B01110,
B01110,
B01110,
B00000,
B11111};
byte batt3[8]={
B11111,
B00000,
B00000,
B00000,
B00000,
B00000,
B00000,
B11111};
byte batt4[8]={
B11111,
B10000,
B00111,
B00111,
B00111,
B00111,
B10000,
B11111};
byte batt5[8]={
B11111,
B10000,
B00000,
B00000,
B00000,
B00000,
B10000,
B11111};
byte batt6[8]={
B00000,
B00000,
B00001,
B00001,
B00001,
B00001,
B00000,
B00000};
byte bluetooth[8]={
B00100,
B00110,
B10101,
B01110,
B01110,
B10101,
B00110,
B00100};
void setup( )
{
Serial.begin(115200);
pinMode(buttonPin, INPUT);
//Establishes initial offset value and prints for reference. Stores value in EEPROM.
offset = EEPROM.read(0);
offset<<=8;
offset|=EEPROM.read(1);
//Sets the reference voltage to 5V
analogReference(DEFAULT);
pinMode(backLight, OUTPUT);
digitalWrite(backLight, HIGH); // turn LCD backlight on. Replace ‘HIGH’ with ‘LOW’ to turn it off.
lcd.begin(16,2); // columns, rows, use 16,2 for a 16x2 LCD, etc.
lcd.clear( ); // start with a blank screen
//Creates Battery inidicator symbol
lcd.createChar(0,batt0);
lcd.createChar(1,batt1);
lcd.createChar(2,batt2);
lcd.createChar(3,batt3);
lcd.createChar(4,batt4);
lcd.createChar(5,batt5);
lcd.createChar(6,batt6);
lcd.createChar(7,bluetooth);
//Set LCD cursor to initial position
lcd.setCursor(15,0);
lcd.write(7);
//wait until stabilization
delay(1000);
}
/*
Conversion based on:
10bit AtoD converter of microcontroller, 5V reference, and 250mV/kPa (sensitivity)
1bit = 1.76 pascals
1kPa = 10.19716 cmH2O
*/
void loop( )
{
//read the sensor
x = analogRead(0);
//convert to cmH2O
cmOfWater = ((x-offset)*.17335) − (((x-offset)*.17335) * .25);
//output the pressure and the iteration number on serial monitor
Serial.print(“[”);
Serial.print(cmOfWater,3);
Serial.print(“]”);
//Checks if pressure is under 15cmH2O
if(−70<=cmOfWater && cmOfWater<15)
{
lcd.setCursor(0,0);
lcd.print(cmOfWater,3);
lcd.print(“ cmH2O ”);
lcd.setCursor(0,1);
lcd.print(“TOO LOW!”);
}
//Checks if pressure is above 25cmH2O
else if(70>=cmOfWater && cmOfWater>25)
{
lcd.setCursor(0,0);
lcd.print(cmOfWater,3);
lcd.print(“ cmH20 ”);
lcd.setCursor(0,1);
lcd.print(“TOO HIGH!”);
}
//Checks if pressure is above 70cmH2O [non linear range of pressure transducer])
else if(cmOfWater>70)
{
lcd.setCursor(0,0);
lcd.print(“Out of Range”);
lcd.setCursor(0,1);
lcd.print(“ ”);
}
//Checks if pressure is below −70cmH2O [non linear range of pressure transducer])
else if(cmOfWater<−70)
{
lcd.setCursor(0,0);
lcd.print(“Out of Range”);
lcd.setCursor(0,1);
lcd.print(“ ”);
}
// Output for safe range
else
{
lcd.setCursor(0,0);
lcd.print(cmOfWater,3);
lcd.print(“ cmH2O ”);
lcd.setCursor(0,1);
lcd.print(“In Range”);
}
//Initiates “Offset reset switch”
buttonState = digitalRead(buttonPin);
//if someone sends a ‘c’ update the offset value
if (buttonState == HIGH)
{
//change offset value:
offset=x;
EEPROM.write(1,offset & 0xFF);
x>>=8;
EEPROM.write(0,x);
}
//Prints battery state
battState = analogRead(battPin);
battState = battState*5/1024;
if(battState>=2*5.0/3)
{
lcd.setCursor(12,1);
lcd.write(6);
lcd.write(4);
lcd.write(2);
lcd.write(0);
}
else if(battState<2*5.0/3 && battState>=5.0/3)
{
lcd.setCursor(12,1);
lcd.write(6);
lcd.write(5);
lcd.write(2);
lcd.write(0);
}
else if(battState<5.0/3 && battState>=.3)
{
lcd.setCursor(12,1);
lcd.write(6);
lcd.write(5);
lcd.write(3);
lcd.write(0);
}
else
{
lcd.setCursor(12,1);
lcd.write(6);
lcd.write(5);
lcd.write(3);
lcd.write(1);
}
//update the iteration and pause a bit.
number++; //to the next character
//Refresh rate of 500ms
delay(500);
}

### Processing Code:

Software below is run on the central PC. It is used to poll data from the prototype and transmit the pressure readings to the designated Pachube server. <worldwideweb.pachube.com/feeds/12410>.

//Prototype to Pachube
//Created: November 7, 2010
//Last Updated: December 2, 2010
import processing.serial.*;
import eeml.*; //Module Necessary for Pachube interface
Serial arduinoPort; // Serial port you are using
float arduinoPressure;
float lastUpdate;
String processingPressure;
DataOut dOut;
void setup( ) {
arduinoPort = new Serial(this, Serial.list( )[12], 115200); //remember to change this value to match
Bluetooth
arduinoPort.clear( );
dOut = new DataOut(this, “http://api.pachube.com/v2/feeds/12410.xml”,
“3c37cc7f46366ea041ae9a1d552b0f134661c6a116cde746259ad81f3b9357ac”);
dOut.addData(2,“Endotracheal Pressure”);
}
void draw( ) {
//println(Serial.list( )); //Comment this in to identify location of Arduino bluetooth port
arduinoPressure = arduinoPort.read( );
if(arduinoPressure == 91){
processingPressure=arduinoPort.readStringUntil(93);
if(processingPressure !=null)
{
processingPressure=processingPressure.substring(0,processingPressure.length( )−1);
println(processingPressure);
if ((millis( ) − lastUpdate) > 6100){
dOut.update(0, processingPressure);
int response = dOut.updatePachube( );
println(response);
lastUpdate = millis( );
}
}
}

### REFERENCES

1. Shipman, N. D. “Endotracheal Tube Cuff Pressure Measuring Device.,” United States Patent Application 20110109458 application Ser. No. 12/613,981, filed Nov. 6, 2009. (Published May 12, 2011).
2. Sengupta, P. et al. (2004) Endotracheal tube cuff pressure in three hospitals, and the volume required to produce an appropriate cuff pressure, BMC Anesthesiology 4(1), 8.
3. Stewart, S. L. et al. (2003) A Comparison of Endotracheal Tube Cuff Pressures Using Estimation Techniques and Direct Intracuff Measurement, AANA J. 71(6), 443-447.
4. Parwani, V. et al. (2007) Practicing paramedics cannot generate or estimate safe endotracheal tube cuff pressure using standard techniques, Prehosp. Emerg. Care 11(3), 307-311.
5. Weymuller Jr., E. “Double-cuffed endotracheal tube,” U.S. Pat. No. 5,033,466 application Ser. No. 07/540,315, filed Jun. 19, 1990. (Published Jul. 23, 1991).
6. O'dea, J. “Apparatus for controlling cuff pressure in an endotracheal tube,” U.S. Pat. No. 6,647,984. (Published Nov. 18, 2003).
7. Jaber, S. et al. (2007) Endotracheal tube cuff pressure in intensive care unit: the need for pressure monitoring, Intensive Care Med. 33(5), 917-918.
8. Vyas, D., Inweregbu, K., and Pittard, A. (2002) Measurement of tracheal tube cuff pressure in critical care, Forum Anaesthesia 57, 266-283.
9. Bernhard, W. N. et al. (1979) Adjustment of Intracuff Pressure to Prevent Aspiration, Anesthesiology 50(4), 363-365.
10. Smaldone, G C. and Palmer, L. B. “Methods, devices and formulations for targeted endobronchial therapy,” U.S. Pat. No. 7,334,580 application Ser. No. 10/430,658, filed May 6, 2003. (Published Feb. 26, 2008).
11. Greear, J. and Fournier, M. W. “Intubation device with adjustable suction means above the cuff,” U.S. Pat. No. 5,067,497 application Ser. No. 07/494,464, filed Mar. 16, 1990. (Published Nov. 26, 1991).
12. ISO11139:2006. (2006) International Organization for Standardization. Sterilization of health care products—Vocabulary, Geneva, Switzerland.

TABLE 1

| Characteristic | Specification |
|---|---|
| Pressure Accuracy | Average + 7% deviation from true value |
| Bluetooth Transmission | >35.4 ft (open air), >22.9 ft (behind wall) |
| Range | |
| Battery Life | 13 hrs |
| Failure Creep Safeguard | Device shuts down at low power levels |
| Physical Dimensions | 5.9 × 2.2 × 1.8 in (15 * 5.5 * 4.5 cm) |
| Weight | 0.471 lbs (213.68 g) |

(Above specifications obtained from test methods described in section v.)

TABLE 2

| | Met |
|---|---|
| Required Specification | Specification? |
| Accurately convert electric signal into pressure value | Yes |
| Incorporate LCD | Yes |
| Incorporate Bluetooth | Yes |
| Battery life >5 hours | Yes |
| Prototype safeguards against failure creep | Yes |
| Size (<8 × 15 × 5 cm) | Yes |
| Weight (<5 lbs) | Yes |

TABLE 3

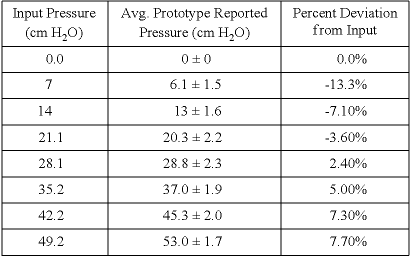

(n = 3 sets of values were examined)

TABLE 4

| | Trial 1 | Trial 2 | Trial 3 | Average | Std. Deviation |
|---|---|---|---|---|---|
| Conditions | (meters) | (meters) | (meters) | (meters) | (meters) |
| Open Air | 10.8 | 11.7 | 28.9 | 17.1 | 10.2 |
| Behind Wall | 7 | 12.5 | 14.8 | 11.4 | 4 |

| | Trial 1 | Trial 2 | | Average | Std. Deviation |
|---|---|---|---|---|---|
| Conditions | (feet) | (feet) | Trial 3 (feet) | (feet) | (feet) |
| Open Air | 35.4 | 38.4 | 94.8 | 56.2 | 33.5 |
| Behind Wall | 22.9 | 41 | 48.6 | 37.5 | 13.2 |

TABLE 5
Time to Failure (hours)

| Trial 1 | Trial 2 | Average | Std. Deviation |
|---|---|---|---|
| 13 hours | Pending | 13 hours | Pending |

TABLE 6

| Avg. | Avg. Reported Pressure at | Average |
|---|---|---|
| Reported Pressure at | Low Power Level | Percent Deviation |
| Full Power (cm H₂O) | (cm H₂O) | from Full Power |
| 0 ± 0 | 0 ± 0 | 0.00 |
| 16.2 ± 1.62 | 15.4 ± 1.8 | 4.86 |
| 30.3 ± 1.9 | 31.0 ± 3.6 | −2.56 |
| 45.3 ± 2.9 | 47.8 ± 5.4 | 5.61 |
| 56.1 ± 2.8 | 62.9 ± 5.4 | 12.19 |

(n = 3 sets of values were examined)

TABLE 7

| | | Thickness | |
|---|---|---|---|
| Length (cm) | Width (cm) | (cm) | Mass (g) |
| 15 | 5.5 | 4.5 | 213.68 |

| Length (in) | Width (in) | Thickness (in) | Mass (lbs) |
|---|---|---|---|
| 5.9 | 2.2 | 1.8 | 0.471 |

TABLE 8

| Part | | PCB | | | |
|---|---|---|---|---|---|
| Number | Component Description | Designator | Manufacturer | Digikey S/C | Quantity |
| 1 | CAP CER 0.1 UF 10% 50 V X7R 0805 | C1, C3, C4 | AVX Corporation | 478-1395-1-ND | 3 |
| 2 | CAP CER 100 PF 50 V C0G 5% 0805 | C2 | TDK Corporation | 445-1329-1-ND | 1 |
| 3 | CAP CERM 22 PF 5% 50 V NP0 0805 | C5, C6 | AVX Corporation | 478-1308-1-ND | 2 |
| 4 | CAP TANTALUM 100 UF 6.3 V 20% | C7, C8 | Kemet | 495-2192-1-ND | 2 |
| | SMD | | | | |
| 5 | IC VREF PREC MICROPWR SOT23-3 | D1 | National Semiconductor | LM4050CIM3-4.1CT-ND | 1 |
| 6 | DIODE SCHOTTKY 20 V 1A DO41 | D2 | Fairchild Semiconductor | 1N5817FSCT-ND | 1 |
| 7 | CHOKE COIL 22 UH 1300 MA SMD | L1 | Panasonic - ECG | PCD2111CT-ND | 1 |
| 8 | HEADER 16 WAYS 2 ROWS | For LCD | Samtec Inc | SAM1096-08-ND | 1 |
| 9 | LIQUID CRYSTAL DISPLAY | LCD | Newhaven Display Intl | NHD-0208AZ-FL-YBW-ND | 1 |
| 10 | HHEADER 2 WAYS | P1 | Samtec Inc | HTSW-101-26-S-D-ND | 1 |
| 11 | HEADER 6 WAYS 2 ROWS | P2 | Samtec Inc | TSW-103-16-T-D-ND | 1 |
| 12 | RES 100K OHM ⅛ W 5% 0805 SMD | R5 | Panasonic - ECG | P100KACT-ND | 1 |
| 13 | RES 680 OHM ⅛ W 5% 0805 SMD | R3 | Panasonic - ECG | P680ACT-ND | 1 |
| 14 | RES 316K OHM ⅛ W 1% 0805 SMD | R6 | Panasonic - ECG | P316KCCT-ND | 1 |
| 15 | RES 412K OHM ⅛ W 1% 0805 SMD | R7 | Panasonic - ECG | P412KCCT-ND | 1 |
| 16 | RES 10K OHM ⅛ W 5% 0805 SMD | R1, R4, R8 | Panasonic - ECG | P10KACT-ND | 2 |
| 17 | RES 1.0K OHM ⅛ W 5% 0805 SMD | R2 | Panasonic - ECG | P1.0KACT-ND | 1 |
| 18 | PRESSURE SENSOR AXIAL PORT | U1 | Freescale Semiconductor | MPXV7007DP-ND | 1 |
| | 8-SOP | | | | |
| 19 | MCU AVR 32K FLASH 28-PDIP | U2 | Atmel | ATMEGA328P-PU-ND | 1 |
| 20 | IC DC/DC CONV STEP-UP 5 V 8-SOIC | U3 | Linear Technology | LT1303CS8-5#PBF-ND | 1 |
| 21 | CRYSTAL 16,000 MHZ 20 PF 49 US | Y1 | ECS Inc | X1103-ND | 1 |
| 22 | SWITCH TACT 6 MM SMD GULL | S1 | TE Connectivity | 450-1130-ND | 1 |
| | WING | | | | |
| 23 | BATTERY HOLDER W/ SWITCH | N/A | MPD (Memory Protection | SBH-321AS-ND | 1 |
| | | | Devices) | | |

What is claimed is:

1. A system comprising: an endotracheal tube cuff in fluid communication with a pressure transducer and a cuff inflating/deflating mechanism, said pressure transducer capable of generating voltage and in electronic communication with a microcontroller, said microcontroller in electronic communication with an alarm.

2. The system of claim 1, wherein said endotracheal tube cuff is attached to an endotracheal tube positioned in a patient.

3. The system of claim 2, wherein said alarm is an audio alarm.

4. The system of claim 2, wherein said alarm is a visual alarm.

5. The system of claim 4, wherein said visual alarm is a display.

6. The system of claim 5, wherein said display is an LCD display.

7. The system of claim 4, wherein said alarm is remote from said tube cuff.

8. The system of claim 7, wherein said alarm is visible from a nurse's station.

9. A method comprising: a) monitoring cuff pressure of endotracheal tube cuff with a pressure transducer, said tube cuff attached to an endotracheal tube, said tube positioned in a patient, said pressure transducer capable of generating voltage and in electronic communication with a microcontroller said microcontroller in electronic communication with an alarm; and b) alerting medical staff when the pressure is outside a desired range with said alarm.

10. The method of claim 9, wherein said monitoring is continuous.

11. The method of claim 9, wherein said monitoring is intermittent.

12. The method of claim 9, wherein the desired range is 20-30 cm H₂O.

13. The method of claim 9, wherein the desired range is 20-25 cm H₂O.

14. The method of claim 9, wherein said alarm is an audible alarm.

15. The method of claim 9, wherein said alarm is a visual alarm.

16. The method of claim 15, wherein said alarm is remote from said tube cuff.

17. The method of claim 16, wherein said alarm is visible from a nurse's station and said medical staff are alerted at said nurse's station.

18. The method of claim 9, wherein said pressure sensor is also in fluid communication with a cuff inflating/deflating means.

19. The method of claim 9, wherein said medical staff adjust said pressure with said inflating/deflating means after being alerted in step b).

20. The method of claim 19, wherein said adjusting comprises pushing or pulling on a syringe, said syringe in fluid communication with said tube cuff.

21. The method of claim 9, wherein said monitoring of step a) comprises generating a voltage with said pressure transducer, and transmitting said voltage to said microcontroller.

22. A device comprising a housing comprising a port, said housing containing a pressure transducer in fluid communication with said port, said pressure transducer capable of generating voltage and in electronic communication with a microcontroller, said microcontroller in electronic communication with an alarm, said microcontroller positioned within said housing, said alarm visible from a surface of said housing.

23. The device of claim 22, wherein said device is portable.

24. The device of claim 22, further comprising an endotracheal tube cuff attached to said port and in fluid communication with said pressure transducer.

25. The device of claim 22, wherein said alarm visible from a surface of said housing is a display.

26. The device of claim 24, wherein said endotracheal tube cuff is further connected to a t-tube connection with a taper male fitting to a forward check valve and a syringe is connected to said t-tube through a forward check valve to said port and is in fluid communication with said pressure transducer.
